(19) United States
(12) Patent Application Publication
(10) Pub. No.: US 2013/0125733 A1
(43) Pub. Date: May 23, 2013

(54) MUSICAL SOUND GENERATOR AND METHOD FOR GENERATING MUSICAL SOUND BASED ON ELEMENT DATA

(71) Applicant: Yamaha Corporation, Hamamatsu-shi (JP)

(72) Inventors: Kouichi KASHIWAZAKI, Hamamatsu-shi (JP); Takehiko Nakao, Hamamatsu-shi (JP)

(73) Assignee: Yamaha Corporation, Hamamatsu-shi (JP)

(21) Appl. No.: 13/742,309

(22) Filed: Jan. 15, 2013

Related U.S. Application Data
(63) Continuation of application No. 11/970,497, filed on Jan. 7, 2008.

(30) Foreign Application Priority Data
Jan. 9, 2007 (JP) 2007-001804
Jan. 9, 2007 (JP) 2007-001806
Jan. 9, 2007 (JP) 2007-001807
Jan. 9, 2007 (JP) 2007-001808

(51) Int. Cl. G10H 1/02

(52) U.S. Cl. CPC G10H 1/02
USPC 84/609

(57) ABSTRACT

In a musical sound generator that generates plural element tones based on plural pieces of element data and generates a musical sound by combining the generated element tones, a selector selects, upon detecting a sound generation control event, one or more pieces of element data among the plural pieces of element data according to the sound generation control event and in the way corresponding to the sound generation type of each of the plural pieces of element data, and a generator generates, in accordance with each of the element data selected by the selector, an element tone having sound characteristics corresponding to the parameter included in the detected sound generation control event and the characteristic control data included in each of the selected element data.

### CROSS REFERENCE TO RELATED APPLICATIONS

This application is a continuation of U.S. patent application Ser. No. 11/970,497, filed Jan. 7, 2008, which claims the benefit of Japanese Patent Application Nos. 2007-001804; 2007-001806; 2007-001807 and 2007-001808, filed Jan. 9, 2007. All these related applications are incorporated by reference in their entirety for all intended purposes.

### BACKGROUND OF THE INVENTION

1. Field of the Invention

The invention relates to a musical sound generator that generates plural element tones based on plural pieces of element data and generates a musical sound by combining the generated element tones, and a method for generating plural element tones based on plural pieces of element data and generating a musical sound by combining the generated element tones.

2. Description of the Related Art

Conventionally, a musical sound generator is known. In the musical sound generator, plural pieces of element data respectively indicating waveform, envelope and the like are provided as voice data (timbre data) specifying a single timbre, and a musical sound specified by the voice data is generated by combining respective element tones generated based on respective element data.

Such a device is described in, for example, the following Document 1.
Document 1: Japanese Patent No. 2842232

In such a musical sound generator capable of using plural pieces of element data, it is known that each element is specified for which note on event the element is to be used (effective) to generate a sound according to ranges of note number or velocity in the note on event and, when an note on event occurs, element data to be used for generating a musical sound is determined according to the note number and velocity of the note on event.

Further, the following Document 2 describes to map waveform data of plural playing methods on an NV plane as showing note numbers in the horizontal axis and velocities in the vertical axis by properly specifying a range, in which the element data is effective, and a content of waveform data specified by the element data, in use of the above function. When this type of mapping is prepared, a playing method can be automatically selected according to note number and velocity according to a key depression operation in response to the key depression operation, and a musical sound in a desired playing method can be outputted.
Document 2: Japanese publication of unexamined patent application No. 2005-107029

It is also known that an electronic musical instrument such as an electronic organ or a keyboard has a function to vary a content of a musical sound according to the performance contents or settings, even when apparently the same timbre is selected.

In such a function, a legato function is known, for example. In a legato playing, note on periods of previous and subsequent key depressions are overlapped. In the legato function, when a legato is set and the legato playing is executed, a portamento process for shifting pitches smoothly from the sound corresponding to the previous note on to the sound corresponding to the subsequent note on is executed, and the sound corresponding to the subsequent note on is generated using data of legato sound, which has less attack influence.

A note off sound generation function is also known, in which a note on sound generation is started in response to a note on while another note off sound generation is started in response to a note off. This function is used to generate a scratching sound of a cembalo. Such a note off sound generation function is described in, for example, the following Document 3.
Document 3: Japanese examined patent publication No. 05-46955

A replaced (random) sound generation function is also known, in which musical sounds having variety of frequency characteristics and characteristics such as pitches are generated according to random values in every note on. This function is used to generate a failed playing and the like. Such a replaced sound generation function is described in, for example, the following Document 4.
Document 4: Japanese Patent No. 2722665

A playing method switching function is also known, in which a playing method switch is provided and musical sound in a playing method corresponding to the currently operated playing method switch is generated in response to a note on. This playing method switch is described in, for example, the following document 5.
Document 5: Japanese Patent No. 3407610

### SUMMARY OF THE INVENTION

However, the above function to vary the content of the musical sound to be generated according to playing content or settings, even in a condition that apparently the same timbre is selected, is conventionally employed only when timbre data created by its manufacturer is used. A function for settings to attain legato function and the like using timbre data created by a user is not provided.

According to the above Document 2, waveforms corresponding to different playing methods can be selectively used for sound generations using a single piece of timbre data. However, in this technique, since waveforms corresponding to the performance methods are mapped, only one playing method can be associated with a particular combination of note number and velocity. Thus, the low degree of freedom for sound generation has been a problem. Further, it has been also a problem that the technique of Patent Document 2 cannot be applied to an operation for selecting waveforms according to relationship among plural note on-s as above described legato function, an operation for selecting waveforms according to event types as above descried note off sound generation function, or an operation, in the replaced sound generation function or performance method switch function, for switching waveforms according to need, even when the note numbers and velocities of the note on-s are the same.

In the synthesizer capable of editing timbre data, timbre data is generally composed of plural elements; however, sound generations of the elements are started in response to a note on, and sound generation controls according to some requirements such as a legato sound generation, a random sound generation, or note off sound generation are not available. In other words, sound generations of the plural elements are executed independently and sound generation based on one element cannot be controlled according to the state of sound generation based on another element.

The invention has been made in view of the above problems and has an object to realize more various sounds in a musical sound generator utilizing editable timbre data having plural pieces of element data each specifying an element tone.

To attain the above object, the invention provides a musical sound generator that generates plural element tones based on plural pieces of element data, and generates a musical sound by combining the generated element tones, including: a memory that stores the plural pieces of element data corresponding to the plural element tones composing a musical sound of a timbre, each piece of the element data including: characteristic control data for controlling a sound characteristic of the corresponding element tone; and type data indicating a sound generation type among a plurality of predetermined sound generation types, each of which corresponds a way to select the piece of the element data; an editor that edits the plural pieces of element data stored in the memory according to an instruction by a user; a selector that selects upon detecting a sound generation control event which includes a parameter and controls sound generation of one musical sound, one or more pieces of element data, to be used in the sound generation of the one musical sound, among the plural pieces of element data according to the sound generation control event and in the way corresponding to the sound generation type indicated by the type data of each of the plural pieces of element data; and a generator that generates, in accordance with each of the element data selected by the selector, an element tone having sound characteristics corresponding to the parameter included in the detected sound generation control event and the characteristic control data included in each of the selected element data.

In such a musical sound generator, it is also preferable that the sound generation control event is a note on event, the predetermined sound generation types include change-off sound, and the selector finds one or more pieces of element data, of which sound generation type is the change-off sound, in the plural pieces of element data and selects a piece of element data among the found one or more pieces of element data, in accordance with a predetermined order or at random.

It is also preferable that the sound generation control event is a note on event, each of the plural pieces of element data includes limit data which limits the use of the element data based on the parameter included in the note on event, the plurality of predetermined sound generation types include change-off sound, and the selector finds one or more pieces of element data, of which the use is permitted based on the parameter in the note on event by the limit data and includes the type data indicating the change-off sound, in the plural pieces of element data, and selects a piece of element data among the found one or more pieces of element data in accordance with a predetermined order or at random.

It is also preferable that the sound generation control event is a note on event, the predetermined sound generation types include change-off sound and non change-off sound, the selector includes a first selector and a second selector, the first selector selects a piece of element data, of which sound generation type is the non change-off sound, among the plural pieces of element data, and the second selector finds one or more pieces of element data, of which sound generation type is the change-off sound, in the plural pieces of element data and selects a piece of element data among the found one or more pieces of element data, in accordance with a predetermined order or at random.

It is also preferable that the non change-off sound is a) normal sound, b) legato sound, or c) one of switch ON sound and switch OFF sound.

It is also preferable that the sound generation control event is a note on event, each of the plural pieces of element data includes limit data which limits the use of the element data based on the parameter included in the note on event, the predetermined sound generation types include change-off sound and non change-off sound, the selector includes a first selector and a second selector, the first selector selects a piece of element data, of which the use is permitted based on the parameter in the note on event by the limit data and includes the type data indicating the non change-off sound, among the plural pieces of element data, and the second selector finds one or more pieces of element data, of which the use is permitted based on the parameter in the note on event by the limit data and includes the type data indicating the change-off sound, in the plural pieces of element data, and selects a piece of element data among the found one or more pieces of element data in accordance with a predetermined order or at random.

It is also preferable that the sound generation control event is a note on event, the predetermined sound generation types include legato sound and non-legato sound, and the selector judges whether or not note on state of an element tone, which is generated in accordance with element data of the legato sound or the non-legato sound in response to detection of previous note on event, is still continuing, when detecting a note on event, and selects i) a piece of element data, of which sound generation type is the legato sound, among the plural pieces of element data, if the note on state is still continuing, or ii) a piece of element data, of which sound generation type is the non-legato sound, among the plural pieces of element data, if the note on state is not continuing.

It is also preferable that the non-legato sound is a) normal sound, or b) one of switch ON sound and switch OFF sound.

It is also preferable that the sound generation control event is a note on event, the parameter included in the note on event is note number, each of the plural pieces of element data includes limit data which limits the use of the element data based on a value of the note number included in the note on event, the predetermined sound generation types include legato sound and non-legato sound, and the selector judges whether or not note on state of an element tone, which is generated in accordance with element data of the legato sound or the non-legato sound in response to detection of previous note on event, is still continuing, when detecting a note on event, and selects i) a piece of element data, of which the use is permitted based on the parameter in the note on event by the limit data and includes the type data indicating the legato sound, among the plural pieces of element data, if the note on state is still continuing, or ii) a piece of element data, of which the use is permitted based on the parameter in the note on event by the limit data and includes the type data indicating the non-legato sound, among the plural pieces of element data, if the note on state is not continuing.

It is also preferable that even if the note on state is still continuing, the selector selects a piece of element data, of which the use is permitted based on the parameter in the note on event by the limit data and includes the type data indicating the non-legato sound, among the plural pieces of element data, when there are no pieces of element data, of which the use is permitted based on the parameter in the note on event by the limit data and includes the type data indicating the legato sound.

It is also preferable that the plural pieces of element data are classified into plural groups, each of the plural pieces of element data includes group data indicating a group to which the element data belongs, and the selector selects a piece of element data, with respect to each of the plural groups, among the element data belonging to one group, according to the sound generation control event and in the way corresponding to the sound generation type indicated by the type data of each of the element data belonging to the one group.

It is also preferable that the sound generation control event is a note on event, the predetermined sound generation types include legato sound and non-legato sound, and the selector judges, with respect to each of the plural groups, whether or not note on state of an element tone, which is generated in accordance with element data of the legato sound or the non-legato sound belonging to one group in response to detection of previous note on event, is still continuing, when detecting a note on event, and selects i) a piece of element data, of which sound generation type is the legato sound, among element data belonging to the one group, if the note on state is still continuing, or ii) a piece of element data, of which sound generation type is the non-legato sound, among element data belonging to the one group, if the note on state is not continuing.

It is also preferable that the sound generation control event is a note on event and a note off event, the plurality of predetermined sound generation types include note on sound and note off sound, the selector includes a first selector and a second selector, the generator includes a first generator, a finder, and a second generator, the first selector selects, upon detecting the note on event, a piece of element data, of which sound generation type is the note on sound, among the plural pieces of element data, the first generator generates the element tone having sound characteristics in accordance with the characteristic control data included in each piece of the element data selected by the first selector, the second selector selects, upon detecting the note off event, a piece of element data, of which sound generation type is the note off sound, among the plural pieces of element data, the finder finds one element tone as characteristic handover source among the element tone being generated by the first generator, and the second generator generates the element tone having sound characteristics in accordance with the characteristic control data included in each piece of the element data selected by the second selector while handing over a part of characteristics of the characteristic handover source to the element tone to be generated.

It is also preferable that the note on sound is a) normal sound, b) legato sound, c) one of change-off sounds, or d) one of switch ON sound and switch OFF sound.

It is also preferable that the sound generation control event is a note on event and a note off event, the plurality of predetermined sound generation types include note on sound and note off sound, the selector includes a first selector and a second selector, the generator includes a first generator, a finder, and a second generator, the first selector selects, upon detecting the note on event, a piece of element data, of which sound generation type is the note on sound, among the element data belonging to one group, with respect to each of the plural groups, the first generator generates the element tone having sound characteristics in accordance with the characteristic control data included in each piece of the element data selected by the first selector, the second selector selects, upon detecting the note off event, a piece of element data, of which sound generation type is the note off sound among the element data belonging to one group, with respect to each of the plural groups, the finder finds one element tone as characteristic handover source among the element tone being generated by the first generator in accordance with the element data belonging to one group, with respect to each of the plural groups, and the second generator generates the element tone having sound characteristics in accordance with the characteristic control data included in each piece of the element data selected by the second selector while handing over a part of characteristics of the characteristic handover source to the element tone to be generated, with respect to each of the plural groups.

It is also preferable that the sound generation control event is a note on event, the predetermined sound generation types include change-off sound, and the selector finds one or more pieces of element data, of which sound generation type is the change-off sound, in the element data belonging to one group, and selects a piece of element data among the found one or more pieces of element data in accordance with a predetermined order or at random, with respect to each of the plural groups.

It is also preferable that the sound generation control event is a note on event, the plurality of predetermined sound generation types include change-off sound and non change-off sound, the selector includes a first selector and a second selector, the first selector selects a piece of element data, of which sound generation type is the non change-off sound, among the element data belonging to one group, with respect to each of the plural groups, and the second selector finds one or more pieces of element data, of which sound generation type is the change-off sound, in the element data belonging to one group, and selects a piece of element data among the found one or more pieces of element data in accordance with a predetermined order or at random, with respect to each of the plural groups.

It is also preferable that the musical sound generator further includes a switch to be switched between ON-state and OFF-state according to an operation by a user, the sound generation control event is a note on event, the plurality of predetermined sound generation types include switch-ON sound and switch-OFF sound, and the selector selects i) a piece of element data, of which sound generation type is the switch-ON sound, among the plural pieces of element data, if the switch is in the ON-state when the note on event is detected, and ii) a piece of element data, of which sound generation type is the switch-OFF sound, among the plural pieces of element data, if the switch is in the OFF-state when the note on event is detected.

It is also preferable that the plurality of predetermined sound generation types further include regular sound, and the selector selects also a piece of element data, of which sound generation type is the regular sound, among the plural pieces of element data regardless of the state of the switch.

It is also preferable that the regular sound is a) normal sound, b) legato sound, or c) one of change-off sounds.

It is also preferable that the musical sound generator further includes a switch to be switched between ON-state and OFF-state according to an operation by a user, the sound generation control event is a note on event, each of the plural pieces of element data includes limit data which limits the use of the element data based on the parameter included in the note on event, the plurality of predetermined sound generation types include switch-ON sound and switch-OFF sound, and the selector selects i) a piece of element data, of which the use is permitted based on the parameter in the note on event by the limit data and includes the type data indicating the switch-ON sound, among the plural pieces of element data, if the switch is in the ON-state when the note on event is detected, and ii) a piece of element data, of which the use is permitted based on the parameter in the note on event by the limit data and includes the type data indicating the switch-OFF sound, among the plural pieces of element data, if the switch is in the OFF-state when the note on event is detected.

It is also preferable that the plurality of predetermined sound generation types further include regular sound, and the selector selects also a piece of element data, of which the use is permitted based on the parameter in the note on event by the limit data and includes the type data indicating the regular sound, among the plural pieces of element data regardless of the state of the switch.

It is also preferable that the parameter is a note number indicating a pitch of the musical sound, and the generator generates the element tone at a pitch corresponding to the note number included in the detected sound generation control event.

It is also preferable that the parameter is a velocity indicating a strength of the musical sound, and the generator generates the element tone at a volume corresponding to the velocity included in the detected sound generation control event.

Further, the invention provides also a method for generating plural element tones based on plural pieces of element data stored in a memory, and generating a musical sound by combining the generated element tones, the memory storing the plural pieces of element data corresponding to the plural element tones composing a musical sound of a timbre, each piece of the element data including: characteristic control data for controlling a sound characteristic of the corresponding element tone; and type data indicating a sound generation type among a plurality of predetermined sound generation types, each of which corresponds a way to select the piece of the element data, the method including: an editing step of editing the plural pieces of element data stored in the memory according to an instruction by a user; a selecting step of selecting upon detecting a sound generation control event which includes a parameter and controls sound generation of one musical sound, one or more pieces of element data, to be used in the sound generation of the one musical sound, among the plural pieces of element data according to the sound generation control event and in the way corresponding to the sound generation type indicated by the type data of each of the plural pieces of element data; and a generating step of generating, in accordance with each of the element data selected in the selecting step, an element tone having sound characteristics corresponding to the parameter included in the detected sound generation control event and the characteristic control data included in each of the selected element data.

The above and other objects, features and advantages of the invention will be apparent from the following detailed description which is to be read in conjunction with the accompanying drawings.

### BRIEF DESCRIPTION OF THE DRAWINGS

FIG. 1 is a diagram showing an outline of a synthesizer as an embodiment of a musical sound generator according to the invention;

FIG. 2 is a diagram showing a configuration of voice data for one timbre used in the synthesizer of FIG. 1;

FIG. 3 is a diagram showing a configuration of sound generation management data used in the synthesizer of FIG. 1;

FIG. 4 is a flowchart of a sound generation instruction process, which is executed by a CPU shown in FIG. 1, in response to a note on event;

FIG. 5 is a flowchart of an effectiveness determination process shown in FIG. 4;

FIG. 6 is a flowchart of a mono mode process shown in FIG. 4;

FIG. 7 is a flowchart of a non-legato and legato sound generation shown in FIG. 4;

FIG. 8 is a flowchart of a cycle sound generation process shown in FIG. 4;

FIG. 9 is a flowchart of a random sound generation process shown in FIG. 4;

FIG. 10 is a flowchart of a sound generation instruction process, which is executed by the CPU of FIG. 1, in response to a note off event;

FIG. 11 is a flowchart of a key off sound generation process shown in FIG. 10;

FIGS. 12A and 12B are explanatory diagrams showing an envelope information handover;

FIGS. 13A to 13D are diagrams showing an illustrative example of selecting elements used for the sound generation according to the process of FIG. 4;

FIGS. 14A to 14D are diagrams showing another example of the element selection;

FIGS. 15A to 15D are diagrams showing another example of the element selection; and FIGS. 16A to 16B are diagrams showing another example of the element selection.

### DETAILED DESCRIPTION OF THE PREFERRED EMBODIMENTS

A preferred embodiment of the invention will be described in detail with reference to the drawings.

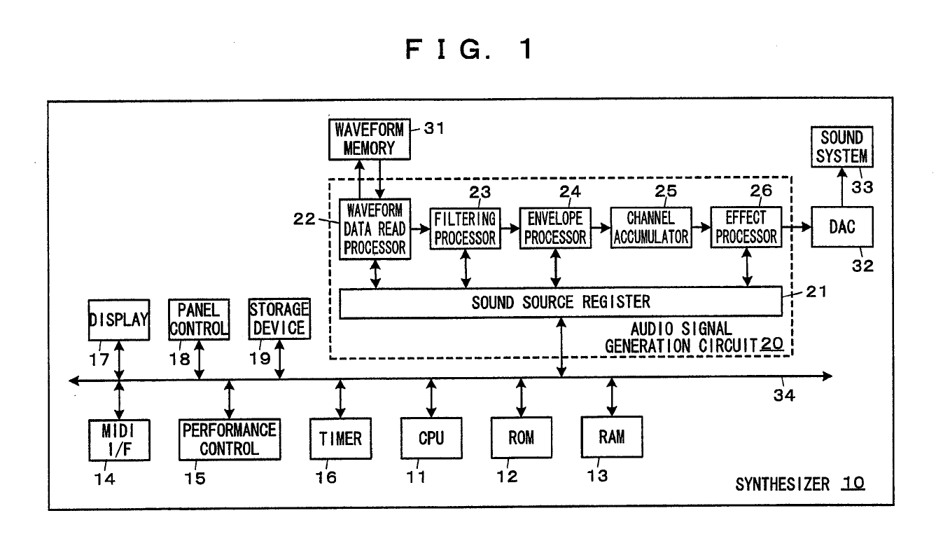

FIG. 1 shows a hardware configuration of a synthesizer as an embodiment of a musical sound generator of the invention.

As shown in FIG. 1, the synthesizer 10 includes a CPU 11, a ROM 12, a RAM 13, an MIDI (Musical Instruments Digital Interface) I/F (interface) 14, a performance control 15, a timer 16, a display 17, a panel control 18, a storage device 19, and a audio signal generation circuit 20, and these components are connected via a system bus 34. The synthesizer 10 further includes a waveform memory 31, a DAC (Digital-Analog Converter) 32, and a sound system 33.

The CPU 11 is a controller, which comprehensively controls the synthesizer 10 and performs control operations such as detecting operation contents in the performance control 15 and panel control 18, controlling displays shown on the display 17, a control of transmissions and receptions of MIDI data via the MIDI I/F 14, and a control of a audio signal generation process in the audio signal generation circuit 20, by executing required control programs stored in the ROM 12 or the storage device 19.

The ROM 12 is a memory for storing control programs executed by the CPU 11 and data which is not to be changed. The ROM 12 can be provided as a rewritable nonvolatile memory such as a flash memory so that the stored data can be updated. The RAM 13 is a memory used as a work memory of the CPU 11 or storing a parameter value and the like which is temporarily used.

The MIDI I/F 14 is an interface for transmitting and receiving MIDI data to and from an external device.

The performance control 15 is an operation device, such as a keyboard or pedals, for accepting a musical operation by a user.

The timer 16 is a timekeeper for measuring time used to control timing in an interrupt processing and the like.

The display 17 is a display device composed of a liquid crystal display (LCD), light-emitting diode (LED) lamps, and the like, and displaying an operation state or settings of the synthesizer 10, a message to a user, a graphical user interface (GUI) for accepting an instruction from a user, and the like.

The panel control 18 is an operation device, such as a key, a knob, a slider and a pitchbend, for accepting a user's setting operation to the synthesizer 10. Also, the panel control 18 includes switches A and B (not shown) used for a later-described element selection.

The storage device 19 is a nonvolatile memory, which is composed of an HDD (Hard Disk Drive), a CD-ROM drive or a magnetic optical (MO) disk drive and stores control programs executed by the CPU 11 and data such as voice data and music data to be edited. The audio signal generation circuit 20 is a waveform generator for generating waveform of musical sounds according to a MIDI event (a performance event for controlling generation of musical sound) generated by the CPU 11 in response to the operation of the performance control 15 or generated by the CPU 11 based on music data in an automatic performance.

More concretely, the audio signal generation circuit 20 includes a sound source register 21, a waveform data read processor 22, a filtering processor 23, an envelope processor 24, a channel accumulator 25, an effect processor 26.

The sound source register 21 has plural sets of registers, each of which corresponds to a sound generation channel, and each of the registers temporarily stores various data, which is written by the CPU 11 via the system bus 34 and used to control respective elements 22 to 26 of the audio signal generation circuit 20. The data includes data specifying a storing address of waveform data to be read, a parameter for generating a filter or an envelop, content of an effect processing to be performed on the waveform data, for example.

The waveform data read processor 22 has a function to read waveform data to be used for sound generation from an address specified in the sound source register 21 among plural waveform data stored in the waveform memory 31, and output the read waveform data (samples) to the filtering processor 23. The reading address progresses at a specified speed according to a pitch of a sound to be generated, and further, the read samples are interpolated to suppress folding noises.

The waveform memory 31 stores plural waveform data corresponding to later described elements. Different waveform data can be prepared for each element in every predetermined pitch ranges (or every pitches) and/or every velocity ranges. Further, the waveform data can be obtained by sampling sounds of an instrument and the like or generated by a calculation. The waveform memory 31 can be composed of a ROM or a RAM. In case of a RAM, when power is supplied, for example, a set of waveform data stored in the storage device 19 and the like is read and stored in the waveform memory 31.

The filtering processor 23 has a function for filter processing the waveform data outputted from the waveform data read processor 22 according to the parameter specified in the sound source register 21 to adjust a frequency characteristic, and outputting the result to the envelope processor 24.

The envelope processor 24 has a function for generating an envelope waveform indicating a temporal change in a sound volume (amplitude) based on a parameter specified in the sound source register 21, and adjusting sound volume of the waveform data outputted from the filtering processor 23 according to the envelope waveform. After this processing, the waveform data is outputted to the channel accumulator 25.

The waveform data read processor 22, filtering processor 23, and envelope processor 24 execute each process in a time-sharing manner at timings corresponding to each sound generation channel within a sampling period. In the synthesizer 10, there are 128 sound generation channels, and processing timings corresponding to the number of the channels are provided. Further, as described later, in the synthesizer 10, plural pieces of element data are prepared for each timbre, and musical sound of the timbre is generated by combining element tones respectively generated according to the prepared element data. A single sound generation channel is used for sound generation based on a single piece of element data. Thus, for example, when four element tones are combined to generate sound of one timbre, four sound generation channels are used for generating the sound.

The channel accumulator 25 has a function to accumulate waveform data respectively outputted from the envelope processor 24 at timings corresponding to the sound generation channels during a sampling period, and output the result to the effect processor 26.

The effect processor 26 has a function to give a musical effect such as a chorus or a reverb to the waveform data outputted from the channel accumulator 25 according to a parameter value set in the sound source register 21, and output the result to the DAC 32 in every sampling period.

The DAC 32 has a function to convert the digital waveform data outputted from the audio signal generation circuit 20 (effect processor 26) into analogue audio signals, and supply the signals to the sound system 33.

The sound system 33 is a sound outputting device, which is composed of a speaker or the like, for outputting sound according to the audio signals supplied from the DAC 32.

The above synthesizer 10 generates and outputs musical sounds of timbres specified by a user, according to the user's performance operations. The synthesizer 10 similarly outputs musical sounds according to an automatic performance. In this case, plural element tones are combined to generate one musical sound of a timbre.

In this case, in response to an occurrence of a note on event (an event instructing a start of sound generation), the CPU 11 instructs the audio signal generation circuit 20 to start generating some required element tones (the number may be 0 or 1), and the audio signal generation circuit 20 starts to generate the element tones. Then, in response to an occurrence of a note off event (an event instructing a start of attenuating sound) corresponding to the note on event, the CPU 11 instructs the audio signal generation circuit 20 to start attenuating (releasing) the element tones, which are generated in audio signal generation circuit 20 in response to the note on event, and the audio signal generation circuit 20 starts to attenuate the element tones.

Regarding the each element tone, a period from the start of sound generation in response to a note on event to the start of attenuation in response to a note off event is referred to as a “note on state” of the element tone. Further, a period from the start of the attenuation to the timing the sound is turned down and vanished is referred to as “release period” of the element tone. The element tone generation is started in response to a note off event in some cases, as described below.

In the synthesizer 10, a user can easily edit timbre data (voice data) including plural pieces of element data used for generating element tones and a specification of a rule, among various rules, for automatic element data determination for generating musical sounds.

Hereinafter, a configuration of the voice data and a sound generation control process according to the voice data will be described in detail. In the following explanation, element data used as a part composing the voice data will simply be referred to as an “element.”

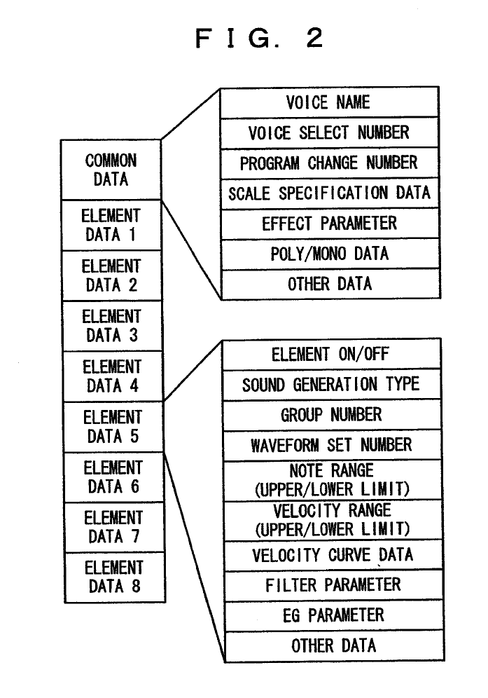

FIG. 2 shows a configuration of voice data for one timbre in form of a data map.

The voice data shown in FIG. 2 is data for plural tones previously stored in the ROM 12 or storage device 19. According to an operation of a user (performer) or a specification of automatic performance data, one piece of voice data is selected as data to be used for sound generation. The CPU 11 reads the selected voice data, stores the data in a voice buffer space secured for each part in the RAM 13, and refers the data when generating sounds. Further, when the data is stored in this way, the elements are grouped and sound generation types are set as described below so that the CPU 11 can function as a group setting device or a type setting device in this process.

As shown in FIG. 2, the voice data includes plural pieces of element data, and common data indicating information of the entire voice. In this example, the number of the pieces of element data is 8.

Here, the common data includes data such as a voice name, a voice select number, a program change number, scale specification data, effect parameter and poly/mono data.

The voice name is a data indicating a name of a voice.

The voice select number and program change number are data indicating numbers to be specified by the control or MIDI program change event when selecting the voice.

The scale specification data is data specifying a unique scale of the voice.

The effect parameter is data indicating a content of common effect given to all element tones.

The poly/mono data is data to specify whether to execute the sound generation according to the voice data in a poly mode, in which a simultaneous sound generation of plural pitches is accepted, or in a mono mode, in which such a simultaneous sound generation is not accepted. In the poly mode, when plural keys are pressed at the same time (at timings overlapping one another), sounds corresponding to all the keys are generated. On the other hand, in the mono mode, when a key is pressed after a previous key, the sound corresponding to the previous key is attenuated (note off) even if the previous key is not released.

Here, the voice can be made applicable to both of the poly/mono modes so that the modes can be switched by a user's operation during a performance.

Each element data includes data such as an element ON/OFF, a sound generation type, a group number, a waveform set number, a note range, a velocity range, a velocity curve, a filter parameter, and an EG parameter.

The element ON/OFF is data specifying effectiveness (ON) and ineffectiveness (OFF) of an element. Only the elements, in which the data indicates effectiveness (ON), are used for the sound generation.

The sound generation type is data specifying a rule (way) used to determine whether or not the element is to be used for the sound generation, as a type of the element. As sound generation types to be specified, there are provided as shown in Table 1. The words shown in the parentheses in addition to the names of concrete sound generation types are classifications based on the functions of sound generation types.

The group number is data indicating an element classification and a rule indicated by the sound generation type is applied with respect to each classified group. Here, the classification can classify the elements into eight groups 1 to 8 and the all elements in one voice can be classified into different groups respectively.

The waveform set number indicates a number of waveform set data used to generate an element tone with a corresponding element. Plural sets of data are numbered and stored in the waveform memory 31 as the waveform set data. When generating an element tone, one of the plural pieces of waveform data is selected from the waveform set data specified by the waveform set number according to a value of a parameter such as note number (pitch) of note on/off event. The selected data is read by the waveform data read processor 21. The waveform set data can be provided as data that is edited by a user. Further, when the waveform data is selected, value of another parameter such as the velocity (strength) of the note on/off event can be used in addition to or as a substitute for the note number.

The waveform set data can include plural pieces of waveform data, and different waveform data can be used according to note number range or velocity range of the note on/off event. Further, the element data can directly specify an address to read the waveform data from the waveform memory 31, as a substitute for the waveform set number.

Each of the note range and velocity range are limit data and specify levels of note number and velocity of the note on event (note off event when the sound generation type is a key off sound), which are used to determine whether to use the element for the sound generation, that is, to limit the use of the element data based on the parameter included in the note on event or note off event. When the note number or velocity is out of the ranges, the element, in which the ranges are set, is not used for the sound generation.

The velocity curve data is data defining a velocity curve used for the element tone generation.

The filter parameter is data defining a type or a characteristic value of a filtering process performed in the filtering processor 23 when generating the element tone.

The EG parameter is data defining a characteristic of an envelope used in various processes performed in the envelope processor 24 when generating the element tone.

Among the above, the waveform set number, velocity curve, filter parameter, and EG parameter are characteristic control data for controlling sound characteristics (such as amplitude changes, pitch changes, waveform shapes) of the element tone.

The user can edit the above described voice data by the panel control 18 of the synthesizer 10 while utilizing the CPU 11 as an editor to edit the data, or by a required application in an external PC (personal computer) and the like, and the result of the edit can be stored in the storage device 19, for example.

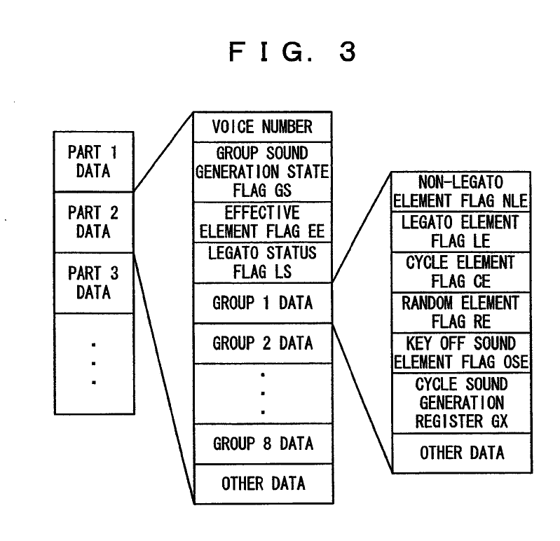

FIG. 3 shows a configuration of sound generation management data used when the CPU 11 instructs the audio signal generation circuit 20 to generate a sound using the above described voice data.

Regarding the sound generation management data shown in FIG. 3, the CPU 11 secures storing space in the RAM 13 and stores the data therein. The CPU 11 also updates the data according to contents of generated note on/off events and refers the data when determining elements to be used to generate sounds corresponding to the performance events.

Since the synthesizer 10 accepts sound generations in plural parts, enough memory space is secured for events generated in each part and management data related to the voice data used for the sound generation in that part. Here, those parts can be set, for example, based on performance controls such as an upper keyboard, a lower keyboard, and a foot keyboard, or key areas, which are divided areas of the keyboards, or performance tracks of an automatic performance. Further, in the synthesizer 10, a tone can be set in each part. When a performance event (MIDI event) of one part is generated, a musical sound to be generated is controlled by using voice data (tone data) which is set in that part.

The sound generation management data of each part includes data such as a voice number, a group sound generation state flag GS, an effective element flag EE, a legato status flag LS, and data related to each group.

The voice number is a number indicating voice data used for sound generation of a corresponding part.

The group sound generation state flag GS is flag data to indicate whether or not there is an element tone which is still in a note on state among non-legato or legato element tones being generated in response to past note on events, with respect to each group. Further, the GS is 8-bit data, and the respective bits correspond to groups 1 to 8 and indicate information related to the groups.

The effective element flag EE is flag data to temporarily indicate elements which are determined to be usable for sound generation in response to a note on event when the note on event is detected. This determination is performed with reference to ON/OFF and limit data of each element. When the sound generation type is a switch basis (sound generation types of all switch OFF, switch A ON or switch B ON), the sound generation type and switch conditions are also referred. Further, the EE is also 8-bit data, and the respective bits correspond to the elements of the groups 1 to 8 and indicate information related to the elements.

The legato state flag LS is flag data to temporarily indicate a result of determination whether or not a detected event is a note on event related to legato playing when the note on event is detected. The LS can be a 1-bit data.

The values of the GS, EE and LS are updated every time a note on event is detected.

The data related to each group includes a non-legato element flag NLE, a legato element flag LE, a cycle element flag CE, random element flag RE, a key off sound generation element flag OSE, and a cycle sound generation register CX.

Among them, the five types of flag data, except of the cycle sound generation register CX, respectively correspond to five sound generation types of non-legato, legato, cycle, random, and key off sound. Each of the flags indicates elements belonging to a corresponding group and being set as a corresponding sound generation type, among the eight elements of the voice data. Here, the elements set in the four sound generation types of normal, all switch OFF, switch A ON, switch B ON are all indicated by the non-legato element flag NLE as a non-legato element.

Each of the flag data is 8-bit data and the respective bits correspond to each of the elements of the voice data. In the flag data of each group, the bits corresponding to the elements belonging to a corresponding group and being set as a sound generation type corresponding to the flag data is set at “1”, and other bits are set at “0”. Each element can belong to only one group and only one sound generation type is set on each element. Accordingly, among bits corresponding to particular element through all flags of the all groups, only one bit is set at “1”. However, plural bits can be set at “1” in one flag data.

That is, when an e-th element belongs to one group and the element is a legato element, an e-th bit is set at “1” in the legato element flag LE of the group, and e-th bit is set at “0” in all other flags including flags of other groups. Further, when the first and second elements belong to one group and both of the elements are cycle elements, the first and second bits in the cycle element flag CE of the group are set at “1”.

The flags of the NLE, LE, CE, RE and OSE are set when voice data is selected in each part, and are not changed until the voice data is changed.

The cycle sound generation register CX is a register for recording a cycle element used for sound generation in response to the latest note on event, and the register CX is referred to when determining a cycle element to be used for sound generation in response to a next note on event. The value of the cycle sound generation register CX is updated every time a note on event is detected. Further, the CX can be provided to all the group data of the groups 1 to 8 or only to group data of a group including a cycle element.

What has been described above is a configuration of sound generation management data.

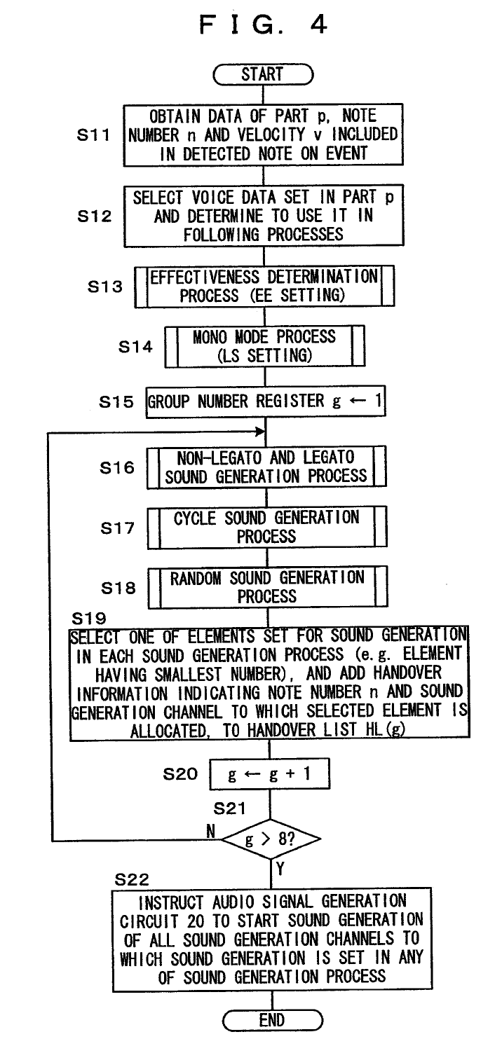

Next, FIG. 4 is a flowchart showing a sound generation instruction process in response to an event, which is executed by the CPU 11 when a note on event is detected. This process is performed by referring to or rewriting the data shown in FIG. 3.

Upon detecting a note on event generated in accordance with a user's performance operation or an automatic performance process, the CPU 11 starts a process shown in the flowchart of FIG. 4.

In this processing, the CPU 11 firstly obtains data of part p, note number n, and velocity v included in the detected note on event (S11).

The note number basically corresponds to a pitch of a sound to be generated, and the velocity basically corresponds to strength of performance operation; however, those correspondence relations are not limited to this.

Next, the CPU 11 refers to a voice number corresponding to the part p obtained in step S11, selects voice data set in the part, and determines to use the selected voice data in the following steps (S12).

Then, the CPU 11 executes an effectiveness determination process (S13) and a mono mode process (S14) to set an effective element flag EE and a legato state flag LS to appropriate values.

Then, the CPU 11 sequentially increases the group number register g from 1 to 8, and executes a non-legato and legato sound generation process (S16), a cycle sound generation process (S17), and a random sound generation process (S18) as regards the groups 1 to 8. Here, the CPU 11 determines elements to be used for sound generation according to sound generation types of the elements belonging to the group (the number of the element to be used may be 0 or 1, ditto for the followings), allocates sound generation channels of the audio signal generation circuit 20 to sound generation based on respective elements determined to be used, and provides settings required for the sound generation to the registers of the allocated sound generation channels of the sound source register 21 (S15 to S21).

Further, the CPU 11 selects one of the elements set for the sound generation to be an element about which envelope information is handed over to the corresponding sound generation in note off state, and adds handover information indicating the current note number n and the sound generation channel to which the selected element is allocated, to a handover list HL(g) of the group under processing (S19). In the process of step S19, the CPU 11 serves as an element tone specification unit.

The handover list HL(g) can be provided in the group data shown in FIG. 3; however, the handover information to be registered is not limited to one piece of information, and information corresponding to all keys in note on state are stored at the same time. Accordingly, it is preferable that the handover list HL(g) is stored separately from the group data since its data amount changes.

Further, the handover information is deleted from the handover list HL(g) when a start of attenuation (release) is instructed to the sound generation channel or when the volume of generated sound is turned down and the sound generation channel is released. Also, the element for handover of the envelope information can be selected automatically in order of smaller element number, or the order of the element selection can be specified by a user. Here, preferably, selected is the element based on which an element tone having the longest sound generation duration among plural element tones simultaneously started in response to the note on event will be generated.

The handover of the envelope information will be described later.

Further, when it is “YES” in step S21, the CPU 11 instructs the audio signal generation circuit 20 to start sound generation of all sound generation channels set in a state of sound generation in any of the sound generation processes in steps S16 to S18 (S22), and completes the process. In response to the instruction to start the sound generation, the audio signal generation circuit 20 generates element tone at a pitch corresponding to the note number n and at a volume corresponding to the velocity v according to the element data of each element set in the register of the sound generation channel, and combines the generated element tones, thereby generating the musical sound corresponding to the detected note on event. In this case, the CPU 11 and audio signal generation circuit 20 serve as an element tone generator.

The processes shown in FIG. 4 will be described in more detail.

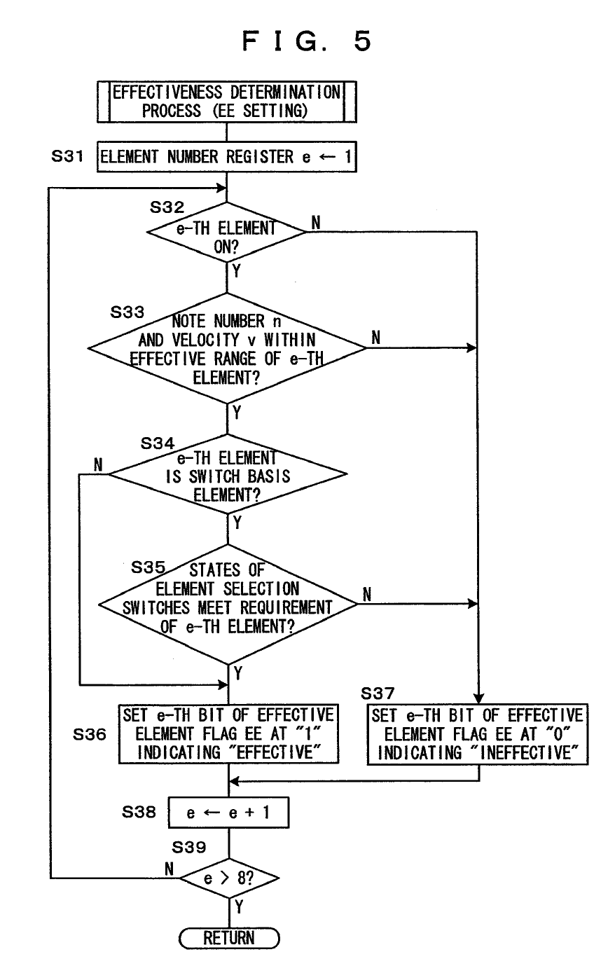

FIG. 5 is a flowchart of the effectiveness determination process in step S13.

In this process, the CPU 11 increases the value of the element number register e one by one, and sequentially executes the processes in steps S32 to S37 for each of the first to eighth elements (S31, S38 and S39).

In this part of the process, the CPU 11 sequentially determines whether or not the element ON/OFF of the e-th element is ON (S32), and whether or not the note number n and velocity v obtained in step S11 of FIG. 4 are within an effective range defined by the note range and velocity range in the element data (S33), that is, the use of the element data is permitted based on the parameter in the note on event by the limit data. Further, when the e-th element is an element of a switch basis (sound generation type of all switch OFF, switch A ON or switch B ON) (S34), the CPU 11 also determines whether or not the states (pressed or not, that is, ON-state or OFF-state) of the element selection switches meet the requirement for the e-th element (S35).

When all these determination is “YES” (also, when the result in step S34 is “NO”), the CPU 11 sets the e-th bit of the effective element flag EE at “1” to indicate that the e-th element is usable for the sound generation in response to the currently detected note on event (S36).

In case that one of the results in steps S32, S33 and S35 is “NO”, the CPU 11 sets the e-th bit of the effective element flag EE at “0”, to indicate that the e-th element is not used for the sound generation in response to the current detected note on event (S37).

When the result in step S39 becomes “YES” after repeating the above processes, the process returns to the process shown in FIG. 4.

With the above described process, it is possible to record in the effective element flag EE which element is usable for a current sound generation among elements included in the voice data used for the sound generation of the part p.

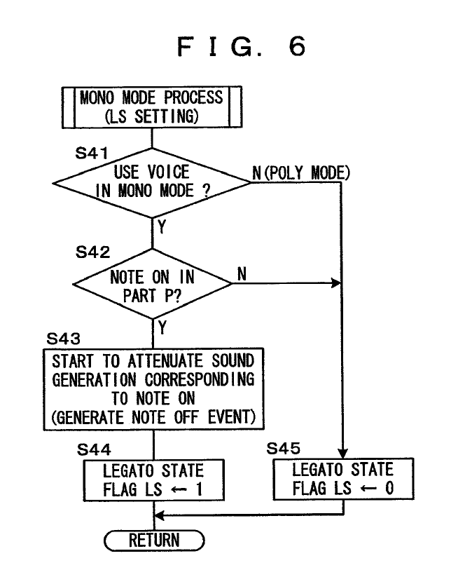

FIG. 6 shows a flowchart of the mono mode process in step S14.

In this process, the CPU 11 refers to the poly/mono data of the voice to be used and determines whether or not the voice is in a mono mode (S41). In case of a mono mode, since a legato function is available, the CPU 11 determines whether or not the current note on event is detected while a previous note on is performed in part p (S42).

When in step S42 is “YES”, the detected note on event is one corresponding to a legato playing in which a next key is pressed before the previous key is released. Accordingly, the CPU 11 generates a note off event corresponding to the previous note on (note off event having the same note number and part as the previous note on), and starts attenuating of the element tone which is being generated in response to the previous note on in the audio signal generation circuit 20 (S43). At the same time, the CPU 11 sets the legato state flag LS at “1” to indicate that a legato performance is executed (S44). Then the process returns to the process shown in FIG. 4.

When the result in step S41 is “NO,” it is in a poly mode and the legato function is not available. Also, when the result in step S42 is “NO,” a legato plying is not executed. Accordingly, the CPU 11 sets the legato state flag LS at “0” to indicate that a legato playing is not executed. Then, the process returns to the process shown in FIG. 4.

With the above process, it is possible to record in the legato state flag LS whether or not a legato playing is executed in the mono mode in which the legato function is available.

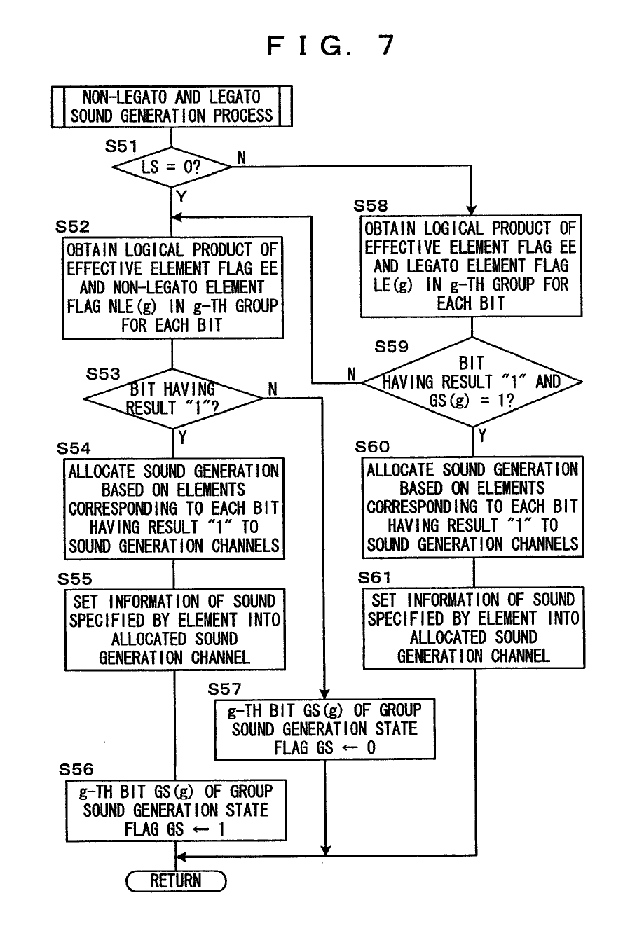

FIG. 7 shows a flowchart of the non-legato and legato sound generation process executed regarding the g-th group in step S16.

In this process, the CPU 11 determines whether or not the value of the legato state flag LS set in the process shown in FIG. 6 is “0” (S51). In case of “0,” since the current note on is not executed by a legato performance, the CPU 11 proceeds to a process from step S52 for generating non-legato sound.

Then the CPU 11 obtains a logical product of the effective element flag EE and the non-legato element flag NLE(g) in the g-th group under processing, for each bit (S52). When the logical product is “1,” it means that the element data indicated by the bit meets the requirement to be used for the sound generation, among the non-legato elements in the g-th group.

What is being processed in this flow is the elements in g-th group. The bit at “1” in the non-legato element flag NLE(g) indicates that the corresponding element is non-legato, and the bit at “1” in the effective element flag EE indicates that the corresponding element is an element which meets the requirements of the note range and velocity range (and switch basis) and is usable for the current sound generation.

Accordingly, when there is a bit whose result becomes “1” (S53), the CPU 11 allocates the sound generation based on an element corresponding to each of the bits to the sound generation channel of the audio signal generation circuit 20, and assures a sound generation channel to generate each element tone (S54). At the same time, the CPU 11 writes information (a parameter for sound generation) of the sound specified by the element data of each element into the allocated sound generation channel (S55).

The setting of the information of the sound is a process to select waveform data corresponding to the note number n and the like from waveform set data indicated by the waveform set number, and to write a read start address, a loop start/end address, a read speed for shifting the waveform data to a pitch corresponding to the note number n, and the like into an area for the waveform data read processor 22 among the registers of the allocated sound generation channel in the sound source register 21. Or the process is to provide a partial modification of the filter parameter or EG parameter according to the note number n and/or velocity v (including a change of an EG parameter to make the value of the envelope waveform to a value indicating a sound volume corresponding to the velocity v), and write the result into the area for the filtering processor 23 or envelope processor 24 among the register of the allocated sound generation channel. Then, when there are plural bits whose results become “1,” the CPU 11 allocates sound generation channels for plural elements corresponding to the respective bits and set the resisters. The start of the sound generation itself is performed later in step S22 shown in FIG. 4.

The CPU 11 then sets the GS(g) to “1”, which is the g-th bit of the group sound generation state flag GS, to indicate an occurrence of sound generation based on a non-legato or legato element in the g-th group (S56), and the process returns to the process shown in FIG. 4.

On the other hand, when there is no bit whose result becomes “1” in step S53, it means that there is no non-legato element to be used for the sound generation in the g-th group, and thus the CPU 11 sets the GS(g) to “0” to indicate that there is no sound generation based on a non-legato or legato element in the g-th group (S57), and the process returns to the process shown in FIG. 4.

The group sound generation state flag GS is used only in a mono mode. When the result is “NO” in step S53 in a mono mode, the GS(g) is set to “0” since neither non-legato sound nor legato sound is in note on state.

When LS is not “0” in step S51, the CPU 11 proceeds to a process from step S58 for generating a legato sound, since the current note on event is generated in response to a legato playing.

Then, the CPU 11 obtains a logical product of the effective element flag EE and the legato element flag LE(g) in the g-th group under processing, for each bit (S58). When the logical product is “1,” it means that the element data indicated by the bit meets the requirement of the note range and velocity range of the element, among the legato elements in the g-th group.

Here, in the synthesizer 10, the legato element is used for sound generation only when the sound generation corresponding to a previous note on event in the same group is performed by using a non-legato or legato element. When such sound generation based on those elements are not performed because of a limitation of note number or velocity or any other reason, a non-legato element is used for the sound generation even when a legato playing is executed.

Accordingly, the procedure proceeds to step S60 and sequential steps to execute a process for setting sound generation based on a legato element (S60, S61) only when there is a bit whose logical product is “1” in step S58, and GS(g)=1 (S59). This process is the same as that in steps S54 and S55, but an element to be used is a legato element.

In general, in a legato element, an attack of the generated element tone is reduced by using waveform set number collecting small attack waveform data or by setting EG parameter having small fast decay. Further, when GS(g)=1 in this situation, it means that the non-legato sound or legato sound is being in a note on state in a mono mode, regarding the g-th group.

After step S61, the process goes back to the beginning. In this case, the GS(g) is already set at “1,” there is not a process to set the GS(g) at “1”; however, such a process can be added.

When the result is “NO” in step S59, the process proceeds to step S52 to consider the sound generation based on a non-legato element.

With the above processes, when there is a non-legato and/or legato element in the g-th group, elements which meet the requirement for the sound generation are searched and a necessary setting for the sound generation based on the searched elements can be executed. In this case, an occurrence or non-occurrence of the legato playing is used as a reference to decide whether the non-legato element or the legato element is to be used for the sound generation.

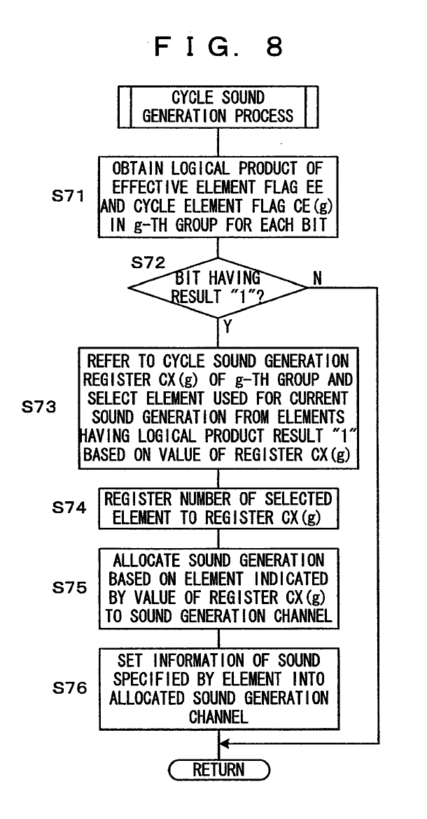

FIG. 8 shows a flowchart of a cycle sound generation process executed for the g-th group in step S17.

In this process, the CPU 11 obtains a logical product of the effective element flag EE and the cycle element flag CE(g) in the g-th group under processing, for each bit (S71). When the logical product is “1,” it means that the element data indicated by the bit meets the requirement of note range and velocity range of the element among the cycle elements in the g-th group.

When there is at least one bit whose result is “1” (S72), the CPU 11 refers to the cycle sound generation register CX(g) of the g-th group and selects an element to be used for the current sound generation from the elements corresponding to bits whose result is “1”, based on a value indicating a cycle element used for the sound generation corresponding to the previous note on event (S73).

An order for this selection can be obtained by, for example, selecting an element which has the smallest number next to the CX(g) among the possible elements, and when there is not such an element, selecting an element which has the smallest number. In this case, for example, when there are three possible elements 1 to 3, the CPU 11 periodically selects each possible element from 1, 2, 3, and 1 in order every time a note on occurs. Further, when EE becomes “0” in an element because of a limitation of note number or velocity at an occurrence of a note on, the element is kept out of the possible elements regarding the note on, and the CPU 11 skips the element and selects a next element.

It is noted that the order for the selection is not limited to the above, and the elements can be selected in a decreasing order or each element can be selected several times in a row by using a counter for counting how many times each element is selected. Or, the elements can be selected according to an order set by a user.

After the above selection, the CPU 11 registers the selected element number to the CX(g) as a reference for the next note on event and, similar to steps S54 and S55 in FIG. 7, executes an allocation of the sound generation channel and setting of musical sound information for a sound generated based on the selected element (S75, S76). Then, the process returns to the process shown in FIG. 4.

With the above described process, when there is a cycle element in the g-th group, the CPU 11 selects an element to be used for the sound generation among them and performs necessary settings for the sound generation based on the element.

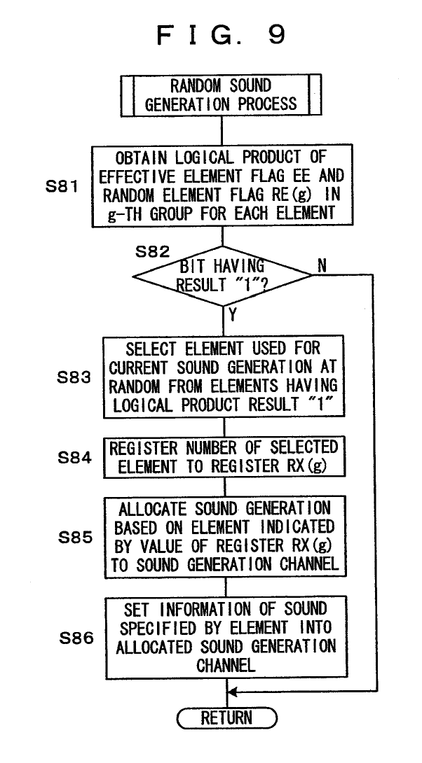

FIG. 9 shows a flowchart of a random sound generation process executed for the g-th group in step S18.

In this process, the CPU 11 obtains a logical product of the effective element flag EE and a random element flag RE(g) of the g-th group under processing, for each bit (S81). When the logical product is “1,” it means that the element data indicated by the bit meets the requirement of the note range and velocity range of the element among the random elements in the g-th group.

Accordingly, when there is a bit whose result becomes “1” (S82), the CPU 11 randomly selects an element to be used for the current sound generation among those elements (S83). Here, the selection does not have to be executed in a complete random manner, and a ratio that each possible element is to be selected can be set.

After this selection, similar to the cases of the steps S54 and S55 in FIG. 7, the CPU 11 performs an allocation of a sound generation channel and setting of the musical sound information to execute the sound generation based on the selected element (S85, S86). Then, the process returns to the process shown in FIG. 4.

With the above process, when there is a random element in the g-th group, the CPU 11 selects an element to be used for sound generation and performs necessary setting for the sound generation based on the element. Here, the sound generation types of the random and cycle are the types of selection sounds.

The processes executed when detecting a note on event have been described. With these processes, element data to be used to generate a musical sound corresponding to a detected note on event is determined according to a rule indicated by a sound generation type of each element, and an instruction can be given to the audio signal generation circuit 20 to generate a waveform of the element tone based on the element data. In this case, the rule indicated by the sound generation type is applied to each group of the element. Also, in these processes, the CPU 11 serves as an element determiner.

FIG. 10 shows a flowchart of a sound generation instruction process corresponding to a note off event (an event instructing a start to attenuate a sound) which is executed when the CPU 11 detects the note off event. This process is also executed as referring to and rewriting each data shown in FIG. 3.

The CPU 11 starts the process of the flowchart shown in FIG. 10 when detecting a note off event generated by a user's performance operation or an automatic performance process.

In this processing, the CPU 11 firstly obtains data of part p and note number n included in the detected note off event (S91). Then, the CPU 11 obtains information of a sound generation channel which performs the sound generation corresponding to the part p and note number n and information of an element used for the sound generation in the channel (S92). This sound generation is sound generation corresponding to a note on event corresponding to the detected note off event (the last note on event having the same part and same note number as those of the detected note off event), and a plural sound generation channels and elements can be found in step S92. Further, when all the sound generations corresponding to the note on event have been stopped, no sound generation channel is found.

After step S92, the CPU 11 sequentially increases a value of the group number register g from 1 to 8, and executes a key off sound generation process for each of the groups 1 to 8 (S94). Here, the CPU 11 determines elements to be used for the sound generation corresponding to the note off event, allocates sound generation channels of the audio signal generation circuit 20 to sound generation based on respective elements determined to be used, and provides settings required for the sound generation to the registers of the allocated sound generation channels of the sound source register 21 (S93 to S96).

When the result is “YES” in step S96, the CPU 11 instructs the audio signal generation circuit 20 to start sound generation of all sound generation channels to which sound generation is set in a state of sound generation in step S94 (S97). In this case, the CPU 11 and audio signal generation circuit 20 serve as an element tone generator.

When a sound generation channel is found in step S92 (S98), the CPU 11 instructs the audio signal generation circuit 20 to start attenuation (release) in the sound generation channel (S99), and completes the process.

With the above described processes, the audio signal generation circuit 20 starts generation of a musical sound corresponding to the note off event, and the audio signal generation circuit 20 also starts the attenuation of the musical sound being generated according to the corresponding note on event, based on the release setting in the EG parameter

FIG. 11 shows a flowchart of the key off sound generation process in step S94.

In this process, the CPU 11 determines whether or not there is a bit at “1” in a key off sound generation element flag OSE(g) of the g-th group (S101). That is, the CPU 11 determines whether or not there is at least one element for a key off sound generation in the g-th group.

When such an element is found, the CPU 11 judges an effectiveness of each found element. In this judgment, an element is judged as an effective element when its element ON/OFF is ON and the note number n of the note off event is within the note range. Here, the velocity is not considered; however, the velocity v of the corresponding note on event can be stored and it can be used in the determination whether or not the value of the velocity is within the velocity range.

In this process, the CPU 11 serves as an element determiner.

After the judgment, the CPU 11 determines whether or not the element is effective (S103). When the element is effective, the CPU 11 performs, on the element as a subject of processing (S104, S112, S113), a process related to sound generation setting in steps S105 to S111. If a plurality of effective elements are found in step S103, the process in steps S105 to S111 are sequentially performed on each of the effective elements.

In this part of process, the CPU 11 firstly allocates sound generation based on the subject element to a sound generation channel (S105).

Then, the CPU 11 determines whether or not there is one or more pieces of handover information in the handover list HL(g) of the g-th group, which is stored in step S19 of FIG. 4 (S 106). When there is no handover information, the CPU 11 does not hand over envelope information and writes note number n and information of musical sound based on the subject element into the sound generation channel which is allocated in step S105 (S107). In this case, sound generation based on the element for a key off sound generation is independently performed according to the note off event. Even when there is not sound generation corresponding to the note on event, sound generation corresponding to the note off event can be performed.

On the other hand, when handover information is found in step S106, the CPU 11 further determines whether or not there is handover information indicating the note number n in the handover information (S108). When there is not such handover information, the CPU 11 stops the sound generation based on the subject element (S109). When such handover information is found, the CPU 11 obtains a value of the current envelope waveform from the sound generation channel indicated by the found handover information (S110), and writes the obtained envelope value, note number n and information of sound based on the subject element into the sound generation channel allocated in step S105 (S111). The process proceeds to step S112 in both cases, and when the result is “NO” in S122, the process returns to the process shown in FIG. 10.

With the above processes, when there are elements for a key off sound generation in the g-th group, the CPU 11 searches elements which meet a requirement for the sound generation, and thus a setting necessary for the sound generation based on the element can be performed. Further, in this case, a value of an envelope waveform of a particular element tone generated in response to a note on event among element tones in the g-th group can be taken over. Further, even when there are plural elements used for the key off sound generation, a correspondence between a handover source and a handover destination can easily be set by grouping the elements.

Since the key off sound generated according to the note off event generally has a short sound generation time, the sound generation channel is released automatically after predetermined period of time because of reduction of the amplitude of the sound, even if there is no instruction to start attenuating.

Such a key off sound generation is a function to reproduce a sound generated during sound generation stop operation when playing an instrument. For example, a sound of a damper contacting to an oscillator to attenuate an oscillation in a key off state is generated in an electronic piano. However, the application of the key off sound generation should not be limited to this. Further, the musical sound characteristic to be tuned over is not limited to the value of the envelope waveform.

Here, a handover of the envelope information will be described with reference to FIGS. 12A and 12B.

The value of envelope is a value that is obtained by converting (scaling down) an envelope waveform in a decibel scale (from 13 to 16 bits: about 10,000 levels) into that of a scale of a MIDI volume parameter (7 bits: 128 levels). Further, FIGS. 12A and 12B schematically show a particular part of an envelope waveform and, in accrual, the length of the key off sound generation is quite shorter than a key on sound generation and each envelope waveform is a little more complex.

A handover of the envelope information is to reflect a value of the envelope waveform used in the process of the envelope processor 24 for the sound being generated, to a value of envelope waveform used in the process of the envelope processor 24 for a sound to be newly generated.

For such handover, simply the value of the envelope waveform (the value at the occurrence of the note off event) obtained from the sound generation channel generating sound can be used as a volume parameter of a sound to be newly generated. This volume parameter is included in the EG parameter and controls a maximum value of envelope waveform to be generated. Or, the obtained value of the envelope waveform is multiplied with a predetermined coefficient (from 0 to 1) and the multiplied result can be used as a sound volume parameter. It is noted that other method can also be employed.

FIGS. 12A and 12B show the former example or the later example, in which the predetermined coefficient is “1”.

FIG. 12A shows an example in which the envelope value of sound generation in response to a note on event is kept at a maximum value 127 (converted value) until note off occurs, as represented by the solid line 41. In this case, an EG parameter to generate an envelope waveform having a maximum value of 127 (converted value) is set in step S111 of FIG. 11. The heavy line 42 represents a temporal change of the envelope value of this case.

On the other hand, FIG. 12B shows another example, in which the envelope value of sound generation in response to a note on event is attenuated from the maximum value 127 (converted value) to 64 (converted value) until note off occurs, as represented by the solid line 43. In this case, an EG parameter to generate an envelope waveform having a maximum value of 64 (converted value) is set in step S111. The heavy line 44 represents a temporal change of the envelope value of this case. Here, to make a comparison with the case of FIG. 12A, the same temporal change as that of the heavy line 42 in FIG. 12A is shown by a broken line 45.

As seen from the FIGS. 12A and 12B, using this type of handover, characteristics in a sound generated in response to a note on event and a sound generated in response to a corresponding note off event can be made continuous and a natural sound generation is realized.

With the above described processes, in the synthesizer 10, since sound generation control based on a sound generation type is performed regarding each part of elements belonging to the same group among plural elements included in one voice data, sound generation based on the plural elements can be controlled in consideration of interrelationship among the respective elements or element tones. Particularly, by defining groups among the elements, it is easy to set from which non-legato sound element to which legato sound element legato is performed, from which note on sound to which note off sound handover of the sound characteristics are performed, or which elements are used for sound generation according to sequential or random selection, with respect to plural elements.

Since a note range and a velocity range can be set for each element, the number of possible element tones for sound generation can be varied according to ranges of a pitch (note number) or performance strength (velocity) of a sound generation instruction event (note on event), in case of a cycle sound generation or a random sound generation (change-off sound generation). Further, an element tone for a non-legato sound generation and an element tone for a legato sound generation can be independently switched according to ranges of a pitch or performance strength of the sound generation instruction event, and also, the numbers of the elements can be selected independently. It is the same in an element tone generated while an element selection switch is operated, and an element tone generated while no element selection switch is operated. Accordingly, various tone changes can easily be obtained.

When a sound generation type for a normal sound (non change-off sound) is provided, a change-off sound generation or a switch basis sound generation can be performed on only appropriately selected elements among plural elements.

When a note on event of a legato playing occurs, it is determined whether or not the sound generation in response to the occurred note on event is performed by a legato sound generation or a non-legato sound generation according to whether the element tone corresponding to a previous note on event is still note on state. Accordingly, a natural legato sound generation can be performed, compared to a conventional method, in which the presence or absence of a legato sound generation is determined based on whether the note on event is related to a legato playing.

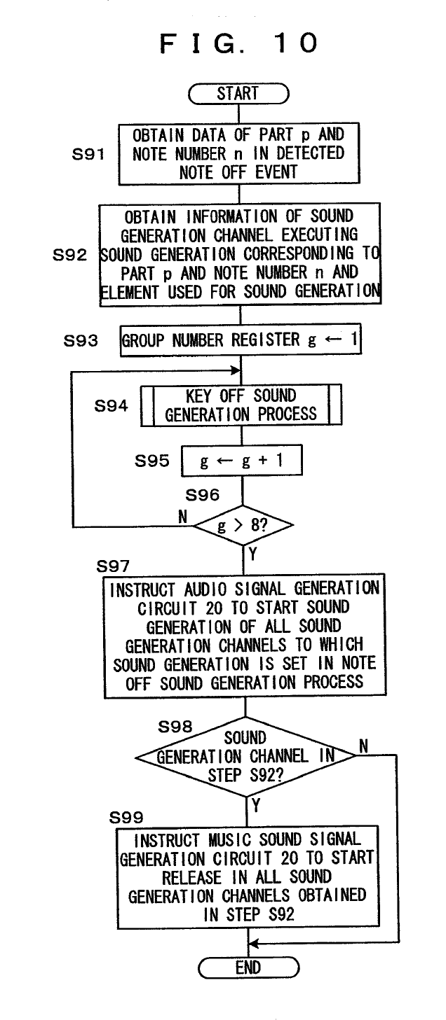

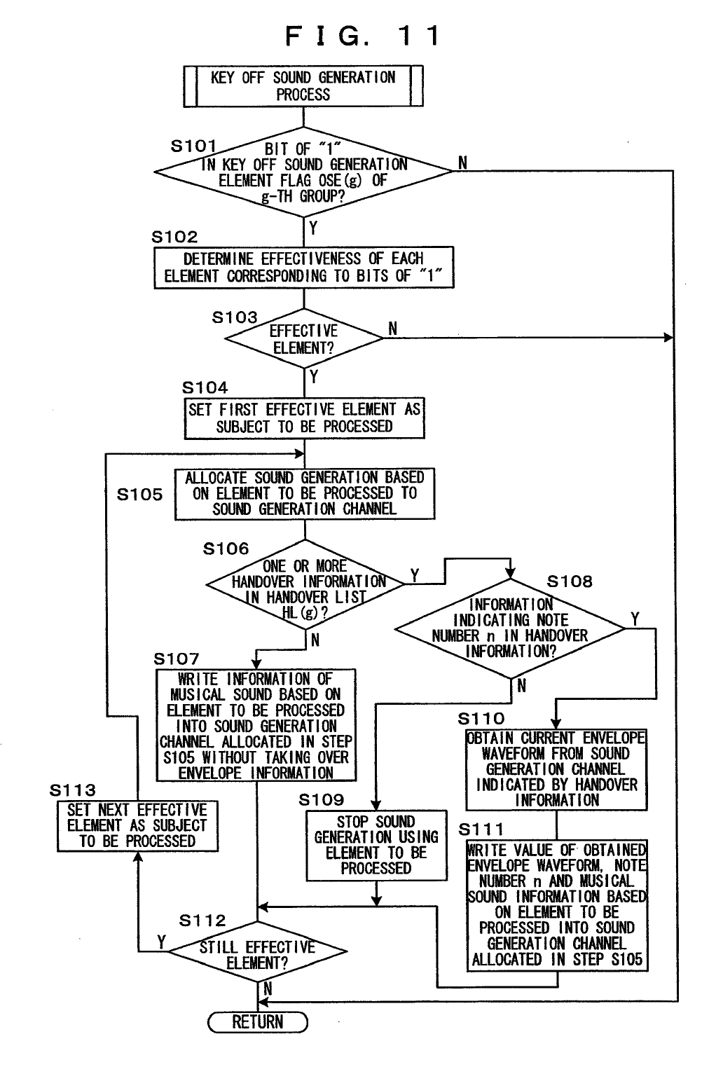

An illustrative example of selecting an element to be used for sound generation according to the process shown in FIG. 4 will be described with reference to FIGS. 13A to 16B.

In these figures, the “eleNO” represents element number, the “GID” represents group ID, the “Type” represents sound generation type of an element. Further, the lines of boxes shown in the right side of those descriptions represent each notes from note number 60(C3) to 78(F#4). The filled boxes show that the element is used for the sound generation of the note. The hatched boxes show that elements are made ineffective in those areas since a note range is set not to include those areas.

These figures show an example in which the playing operation is performed in an ascending order regarding the note number; however, it is noted that the order of performance can arbitrarily be selected in actual playing operation.

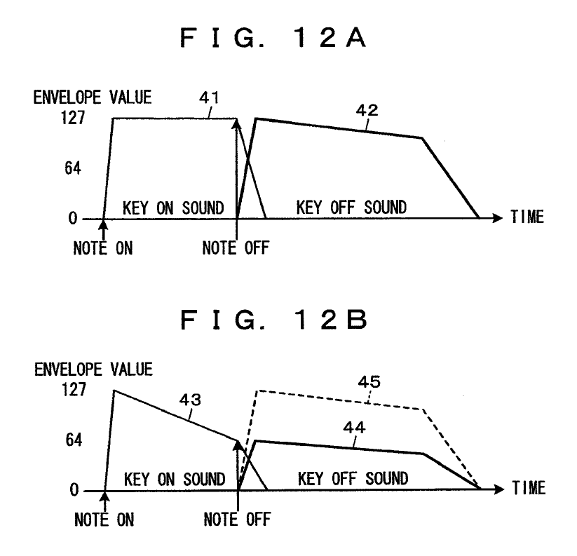

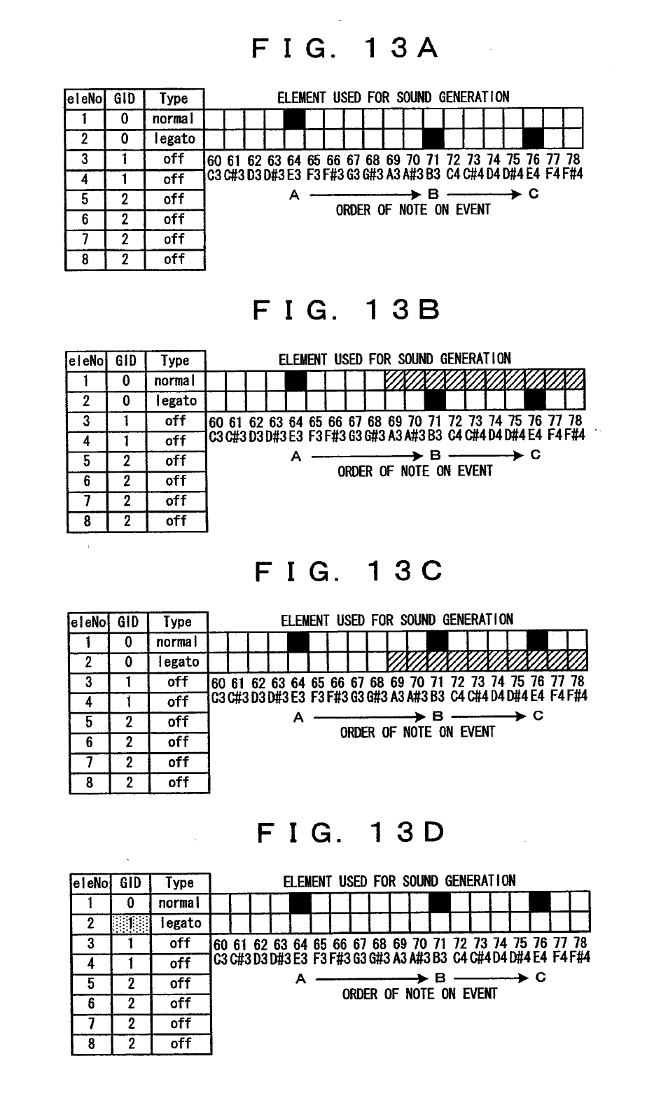

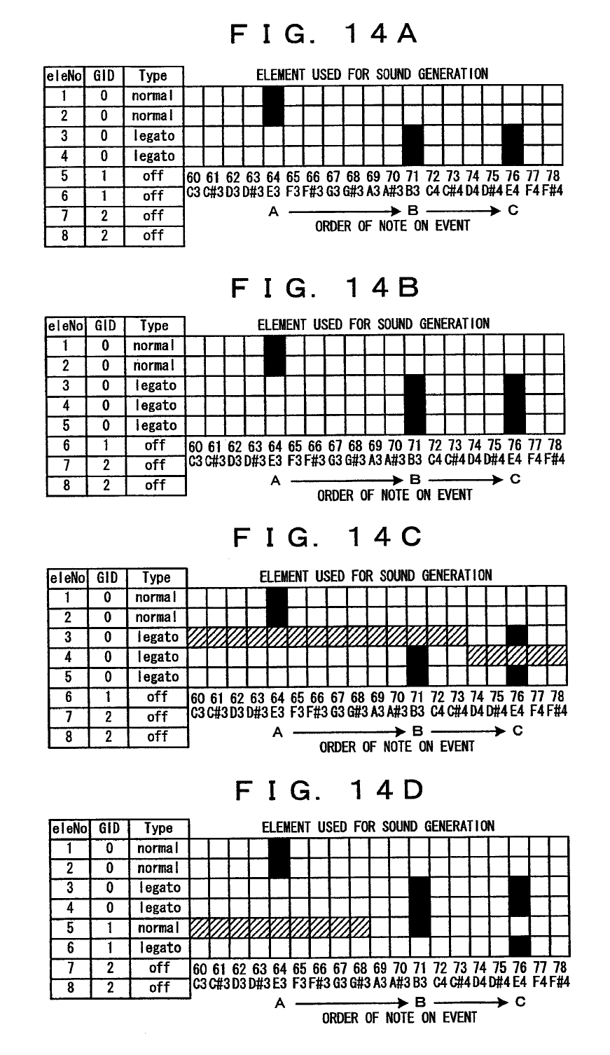

FIGS. 13A to 14D show examples in which a legato element exists. In these figures, an example of element selection when note on event of three notes (E3, B3, E4) of A(64), B(71), C(76) occurred in this order in a manner representing legato playing.

FIG. 13A shows a most typical example, in which a normal (non-legato) element and a legato element are provided within a group. In this case, at the first note on event, sound generation is executed using a normal element 1, and then, since a legato performance is performed, sound generation is executed using a legato element 2, as a substitute for the normal element.

FIG. 13B shows an example in which a limitation of a note range is given to the normal element. In this case, also, the legato element is usable at the note on events B, C, so the requirement that a non-legato or legato element is used in the previous note on event is satisfied. Accordingly, sound generations are executed, similar to the case of FIG. 13A.

FIG. 13C shows an example in which a limitation of note range is given to a legato element. In this case, there is no effective legato element in the group at the note on events B, C, so the result in step S59 of FIG. 7 is “NO.” Accordingly, sound generations using normal elements are executed.

FIG. 13D shows an example in which a group of the normal element and a group of the legato element are different. Since rules for element selection are applied with respect to each group, there is no effective legato element in the group 0. Accordingly, similar to the case of FIG. 13C, the sound generations are executed using normal elements even when a legato performance is performed. Further, only legato element 2 exists in the group 1. Thus, since the requirement that a non-legato or legato element is used in a previous note on event is not satisfied in the group 1, the element 2 is not used for the sound generation.

FIG. 14A shows an example in which two normal elements and two legato elements are provided in the group 0, and FIG. 14B shows an example in which two normal elements and three legato elements are provided. Even when the number of the elements in a group changes in this way, it is the same that normal elements are used for the sound generation in response to the first note on event A and legato elements are used for the sound generation in response to the note on events B, C according to legato playing.

In the cases of FIGS. 14A and 14B, a musical sound in different timbre combining plural element tones can be generated during normal and legato performances. Further, the number of element tones to be combined can be individually changed for the normal and legato playing by changing the settings of the group and sound generation type for each element. Accordingly, voice data can be edited easily in high degree of freedom.

For example, in case that there is a voice data of a flute such as:

element 1 (group 1, normal): first flute normal sound; and

element 2 (group 1, legato): first flute legato sound,

it is easy to add elements to modify the data to a voice data of two flutes such as:

element 1 (group 1, normal): first flute normal sound;

element 2 (group 1, legato): first flute legato sound;

element 3 (group 2, normal): second flute normal sound; and

element 4 (group 2, legato): second flute legato sound.

Although it is not shown in these figures, regarding the sound generation types for a key off sound, the number of element tones to be combined can be individually changed for the sound generations according to note on and note off by changing the settings in the group and sound generation types of each element. Accordingly, also in this view point, the voice data can be edited easily in high degree of freedom.

FIG. 14C shows an example in which a limitation of note range is given to a part of legato elements. In this case, only the legato elements within the note range are used for the sound generation of a legato performance. Accordingly, it is possible to change a timbre of a sound generated according to legato playing according to its note range.

FIG. 14D shows an example in which normal and legato elements are provided to each of the groups 0, 1, and a limitation of note range is given to the normal element in the group 1. Since the rules for element selection are applied with respect to each group, the sound generation in the group 0 is executed in the same way shown in FIG. 14A. In the group 1, however, at the first note on event A, there is no effective normal element, so sound generation is not executed. Then, at the following note on event B, the normal element is used even if it is a note on event according to legato playing, since the requirement that a non-legato or legato element is used in a previous note on event is not satisfied.

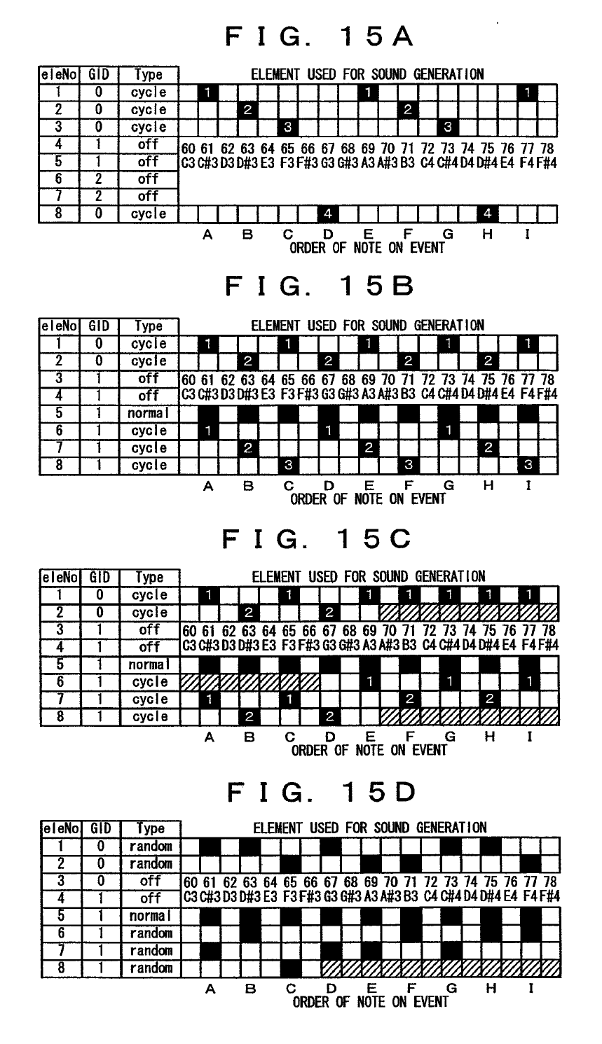

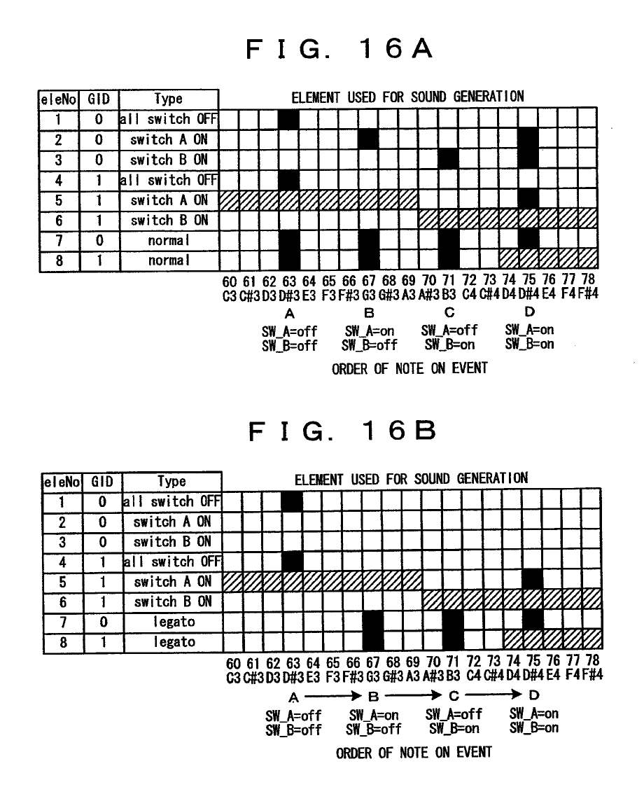

FIGS. 15A to 15D show examples in which there are cycle and random elements which are replaced elements. These figures show examples of element selections when note on events occur at nine notes (C#3, D#3, F3, G3, A3, B3, C#4, D#4, F4) from A(61) to H(77) in this order.

FIG. 15A shows an example in which a sound generation type of cycle is given to four elements in the group 0. In this case, every time a note on event occurs, an element used for the sound generation is selected in an ascending order within the group, and when an element having the largest number is selected, the selection repeats from the element having the smallest number. The continuity of the element number does not influence the operations.

FIG. 15B shows an example in which two cycle elements are provided in the group 0 and three cycle elements and a normal element as a non change-off sound are provided in the group 1. In this case, every time a note on event occurs, an element used for the sound generation is selected in an ascending order in each group. Since the number of the cycle elements differs in each group, a cycle length for the selections differs in each group. Further, the normal element is always used for sound generations, regardless of the cycle elements.

As described above, in the synthesizer 10, sound generation in a quite new timbre wherein the tone periodically changes can be performed simply by specifying “cycle” in some elements as the sound generation characteristic. Further, the element selection cycle can be changed simply by changing the number of cycle elements provided in the group. Further, in view of the combinations of the sound generation in the groups 0 and 1, sound generation can be performed as periodically switching six tones with five elements in actual. Accordingly, a variety of sound generation can be performed with a small amount of data.

FIG. 15C shows an example in which a limitation by note range is given to a part of the cycle element. In this case, elements are selected as considering that the element does not exist in the range in which the element is made ineffective because of the settings in note range. Accordingly, candidate elements vary according to the note number of the note on event.

FIG. 15D shows an example in which random elements are provided. In this case, the operation is the same as the case of the cycle elements, except for that the elements used for the sound generation are selected at random. However, because of its randomness, sound generations having more variety and unpredictability can be executed, compared to the case of cycle elements.

Here, it is possible to provide both of cycle elements and random elements within a same group; however, in this case, one element is respectively selected for the sound generation from the cycle elements and the random elements in accordance with respective rules thereof.

FIGS. 16A and 16B show examples in which switch basis elements exist. These figures show examples of element selections when note on events occur at four notes (D#3, G3, B3, D#4) from A(61) to D(75) in this order. Further, “SW_A” and “SW_B” represents the state of the element selection switches A and B when the events occur.

In the case of FIG. 16A, the sound generation types of switch basis are set in the elements 1 to 6. Then, it is determined whether or not the element is used for the sound generation according to state of the element selection switches. Further, state of the element selection switches does not influence the normal elements. The limitations of a note range or a velocity range are applied.

FIG. 16B shows an example in which a sound generation type of legato is given to the elements 7, 8, and the note on events are generated according to a legato playing. Since the switch basis sound generation type is also “non-legato”, legato elements are used instead of switch basis elements for sound generations when a legato element exists within the same group and the usage requirement is satisfied. The determination whether or not the legato elements are used does not depend on the state of the element selection switch; however limitations of note range or velocity range are applied.

With such switch basis elements, it is possible to easily switch the playing methods, set chorus effect ON and OFF, add an instrument to performance section, and the like.

For example, a voice data of guitar timbre by which sound of normal playing, harmonics playing and mute playing can be selectively obtained by operating the element selection switches A and B is realized by providing following elements in the voice data:

element 1 (group 1, all switch OFF): attack noise;

element 2 (group 1, all switch OFF: normal sound;

element 3 (group 1, switch A ON): harmonics sound; and

element 4 (group 1, switch B ON): mute sound.

For another example, a voice data of organ timbre by which basic percussion sound and optional chorus sound can be obtained and ON/OFF of the chorus sound can be selected by the element selection switch A is realized by providing following elements in the voice data:

element 1 (group 1, normal): percussion sound;

element 2 (group 1, all switch OFF): chorus OFF sound; and

element 3 (group 1, switch A ON): chorus ON sound.

Further, a voice data of strings section timbre by which basic violin sound and additional cello and contrabass sound can be obtained and addition of the cello and contrabass sound can be controlled by the element selection switch A and B is realized by providing following elements in the voice data:

element 1 (group 1, normal): violin tone;

element 2 (group 1, switch A ON): cello tone; and

element 3 (group 1, switch B ON): contrabass tone.

Further, a voice data of orchestra section timbre by which basic sound of strings part and additional sounds of winds part and tympani part and addition of the winds part and tympani part can be controlled by the element selection switch A and B is realized by providing following elements in the voice data:

element 1 (group 1, normal): strings tone;

element 2 (group 1, switch A On): winds tone; and

element 3 (group 1, switch B On): tympani tone.

In all of the above examples, the elements, which are shown as being a single element, can be composed of plural elements so that sound generations corresponding to a single playing method, instrument, or part can be performed by combining plural element tones.

Further, for example, regarding above voice data of strings section timbre, in order to allow generation of legato sounds of each instrument, the elements can be divided into groups as follows:

element 1 (group 1, normal): violin tone (normal);

element 2 (group 2, switch A On): cello tone (normal);

element 3 (group 3, switch B On): contrabass tone (normal);

element 4 (group 1, legato): violin tone (legato);

element 5 (group 2, legato): cello tone (legato); and

element 6 (group 3, legato): contrabass tone (legato).

With this structure, legato sound generation is realized while addition of instruments by pressing the element selection switch is kept possible.

Such a modification of setting can be made by simply adding elements or changing the sound generation types and groups of elements. Accordingly, also in view of this point, voice data used in the synthesizer 10 can be edited easily in high degree of freedom.

The above is the description of an embodiment; however, it should be appreciated that the embodiment should not be limited to the above described device configuration, data configuration, element data contents, concrete process contents, and the like. For example, according to the above embodiment, the handover of envelope value is executed only when an element for a key off sound generation is used for sound generation; however, such handover can also be executed when other elements are used for sound generation (in the case of sound generation performed in response to a note on event). Particularly, it is preferable that a handover of an envelope value can be executed in the case of legato sound generation, performance in a portamento setting, or sound generation based on a mono mode element.

Also, the number of elements included in a piece of voice data and the number of settable groups are not limited to eight. The number of elements can be variable for respective voice data. The grouping of elements itself is not essential.

Further, the sound generation types of elements, that is, a rule to determine whether or not the element data is used to generate a musical sound corresponding to a performance event, are not limited the above. Contrary, any of the above described sound generation type can be omitted. In such a case, effects of every existing sound generation type can be obtained.

Regarding the limit data, both of the note range and velocity range are not always required, and it is possible to employ one of the note range and velocity range.

According to the above embodiment, although the normal and switch basis sound generation types are set as non-legato, random and cycle sound generation types are not set as non-legato or legato. However, such settings are not limited to the above, and it can be arbitrarily determined which sound generation type is set as non-legato and stop to generate sound based on the element when legato sound is generated, or which sound generation type is set as legato and start to generate sound based on the element when a legato playing is performed.

It is also conceivable that a user can set the respective sound generation types as non-legato, legato, or a type unrelated to a legato performance. Or, substitute for setting of the sound generation types, setting of the respective elements as non-legato, legato, or a type unrelated to a legato performance is also conceivable.

Regarding the legato sound generation, according to the above embodiment, even when a legato element exists and GS(g)=1, a non-legato sound is generated instead of the legato sound if the note number of the note on event is out of the note range for the legato element (if the result in step S59 of FIG. 7 is “NO”). However, in such a case, it is possible to generate none of the legato and non-legato sounds.

When an occurred note on event is one according to legato playing in the mono mode (the result in step S42 in FIG. 4 is “YES”), release of the previous sound is started regardless of the condition. Here, a dumping (rapid attenuating) can be executed as a substitute for releasing. Further, in a legato playing, when there is no element to be used for sound generation in response to note on, and a new sound generation is not performed (when the results in steps S53 and S59 in FIG. 7, step S72 in FIG. 8, and step S82 in FIG. 9 are all “NO”), the start of releasing the previous sound is not always required.

According to the above embodiment, two switches A and B are provided as element changeover switches; however, the number of the switches can be determined arbitrary. In addition, it has been described that, when plural switches are turned on at the same time, the elements having sound generation types set as “switch ON” related to one of the turned-on switches are all used for the sound generation. However, it is possible to provide sound generation types of “switch ON” corresponding to combinations of turned-on switches, and use only elements having the sound generation type indicating a completely same combination of turned-on switches.

Further, as regards classifications of sound generation types, they can be modified, for example as follows: any of normal sound, legato sound, switch ON sound, and switch OFF sound can be classified as the non change-off sound; any of normal sound, switch ON sound, and switch OFF sound can be classified as the non-legato sound; any of normal sound, legato sound, change-off sound, switch ON sound, and switch OFF sound (all types other than note off sound) can be classified as the note on sound; and any of normal sound, legato sound, and change-off sound can be classified as the regular sound.

According to the above embodiment, selection of an element from which envelope information is taken over to sound generation corresponding to a note off event is executed as a process in response to an occurrence of a note on event in step S19 in FIG. 4. However, the selection is not required in that timing, and it is conceivable that an element tone having the largest envelope waveform value among element tones started to be generated at the timing of corresponding note on event can be selected in each element group to take over the value, at the process in response to an occurrence of a note off event in step S106 in FIG. 11.

According to the above embodiment, the synthesizer 10 having a keyboard is described as an example; however, the present invention can be applied to other types of musical sound generators such as an electrical musical instrument having a performance control other than a keyboard, a tone generator which does not have a performance control, and an expansion board or a chip for generating musical sound. Further, as a performance event to activate the audio signal generation circuit 20, the device can use data other than MIDI data.

The program of the present invention is a program to control a computer to serve as a musical sound generator and realize the above described functions. The program can be stored in a ROM, HDD and the like in advance. Or the program can be recorded in a nonvolatile recording medium (memory) such as a CD-ROM and a flexible disk and read into the RAM from the memory so that the CPU can execute the program. The program can be downloaded from an external device including a medium storing the program or an external device storing the program in its memory such as an HDD. The same effect can be obtained in any of the above method.

Further, these modifications described above are applicable in any combination in a range without contradiction.

As seen in the above description, according to the musical sound generator or musical sound generation method of the present invention, element data to be used for generating element tone can be switched dynamically for each sound generation according to the sound generation control event and the sound generation type, thereby various sounds can be generated in a musical sound generator utilizing editable timbre data having plural pieces of element data each specifying an element tone.

Further, the invention improves an operability and user-friendliness of the musical sound generator.

TABLE 1

| Sound | |
|---|---|
| Generation Type | Description |
| normal | used for sound generation at a note on event |
| (non-legato sound) | (except for a case that legato sound is used) |
| (non change-off | |
| sound) (regular | |
| sound) | |
| legato | used for sound generation, substitute for non-legato |
| (legato sound) | element, at a note on event of legato playing method |
| key off sound | used for sound generation in response to note off |
| (note off sound) | event |
| cycle | select an element used for sound generation from |
| (change-off sound) | same type elements according to a particular order |
| | at a note on event |
| random | select an element used for sound generation from |
| (change-off sound) | same type elements in a random manner at a |
| | note on event |
| all switch OFF | used for sound generation at a note on event when |
| (non-legato sound) | none of the element selection switches A, B are |
| (switch OFF sound) | pressed (except for a case that legato sound |
| | is used) |
| switch A ON | Used for sound generation at a note on event when |
| (non-legato sound) | the element selection switch A is pressed |
| (switch ON sound) | (except for a case that legato sound is used) |
| switch B ON | Used for sound generation at a note on event when |
| (non-legato sound) | the element selection switch B is pressed |
| (switch ON sound) | (except for a case that legato sound is used) |

(The sound generation types other than the key off sound are classified as note on sound.)

What is claimed is:

1. A musical sound generator that generates plural element tones based on plural pieces of element data, and generates a musical sound by combining the generated element tones, comprising:
a memory that stores the plural pieces of element data corresponding to the plural element tones constituting a timbre of the musical sound, each piece of the element data including: limit data which indicates a note number range in which corresponding element tone is generated; characteristic control data for controlling a sound characteristic of the corresponding element tone; and type data indicating whether the sound generation type of the element data is legato sound or non-legato sound;
a selector that judges, upon detecting a note on event which instructs to start generation of one musical sound and includes a note number, whether or not note on state of an element tone, which is generated in accordance with element data of the legato sound or the non-legato sound in response to detection of previous note on event, is still continuing, and selects, as element data to be used in generation of a new musical sound in response to the detected note on event, i) a piece of element data for which the note number in the detected note on event falls within the note number range, among element data of which sound generation type is the legato sound, if the note on state is still continuing, or ii) a piece of element data for which the note number in the detected note on event falls within the note number range, among element data of which sound generation type is the non-legato sound, if the note on state is not continuing; and
a generator that generates, in accordance with the characteristic control data included in each piece of the element data selected by said selector, an element tone having sound characteristics indicated by the characteristic control data and pitch corresponding to the note number in the detected note on event.

2. A musical sound generator according to claim 1, wherein
even if the note on state of the element tone generated in accordance with the element data of the legato sound or the non-legato sound in response to the previous note on event is still continuing, said selector selects, as element data to be used in generation of the new musical sound in response to the detected note on event, a piece of element data for which the note number in the detected note on event falls within the note number range, among the element data of which sound generation type is the non-legato sound, when there are no pieces of element data for which the note number in the detected note on event falls within the note number range among the element data of which sound generation type is the legato sound.

3. A musical sound generator that generates plural element tones based on plural pieces of element data, and generates a musical sound by combining the generated element tones, comprising:
a memory that stores the plural pieces of element data corresponding to the plural element tones constituting a timbre of the musical sound, each piece of the element data including: limit data which indicates a velocity range in which corresponding element tone is generated; characteristic control data for controlling a sound characteristic of the corresponding element tone; and type data indicating whether the sound generation type of the element data is legato sound or non-legato sound;
a selector that judges, upon detecting a note on event which instructs to start generation of one musical sound and includes a velocity, whether or not note on state of an element tone, which is generated in accordance with element data of the legato sound or the non-legato sound in response to detection of previous note on event, is still continuing, and selects, as element data to be used in generation of a new musical sound in response to the detected note on event, i) a piece of element data for which the velocity in the detected note on event falls within the velocity range, among element data of which sound generation type is the legato sound, if the note on state is still continuing, or ii) a piece of element data for which the velocity in the detected note on event falls within the velocity range, among element data of which sound generation type is the non-legato sound, if the note on state is not continuing; and
a generator that generates, in accordance with the characteristic control data included in each piece of the element data selected by said selector, an element tone having sound characteristics indicated by the characteristic control data and volume corresponding to the velocity in the detected note on event.

4. A musical sound generator according to claim 3, wherein
even if the note on state of the element tone generated in accordance with the element data of the legato sound or the non-legato sound in response to the previous note on event is still continuing, said selector selects, as element data to be used in generation of the new musical sound in response to the detected note on event, a piece of element data for which the velocity in the detected note on event falls within the velocity range, among the element data of which sound generation type is the non-legato sound, when there are no pieces of element data for which the velocity in the detected note on event falls within the velocity range among the element data of which sound generation type is the legato sound.

5. A musical sound generator according to claim 1, wherein
said non-legato sound is a) normal sound, b) switch ON sound or c) switch OFF sound.

6. A musical sound generator according to claim 2, wherein
said non-legato sound is a) normal sound, b) switch ON sound or c) switch OFF sound.

7. A musical sound generator according to claim 3, wherein
said non-legato sound is a) normal sound, b) switch ON sound or c) switch OFF sound.

8. A musical sound generator according to claim 4, wherein
said non-legato sound is a) normal sound, b) switch ON sound or c) switch OFF sound.

9. A method for generating a musical sound by generating plural element tones based on plural pieces of element data and combining the generated element tones, comprising:
a step of preparing a memory that stores the plural pieces of element data corresponding to the plural element tones constituting a timbre of the musical sound, each piece of the element data including: limit data which indicates a note number range in which corresponding element tone is generated; characteristic control data for controlling a sound characteristic of the corresponding element tone; and type data indicating whether the sound generation type of the element data is legato sound or non-legato sound;
a selecting step of judging, upon detecting a note on event which instructs to start generation of one musical sound and includes a note number, whether or not note on state of an element tone, which is generated in accordance with element data of the legato sound or the non-legato sound in response to detection of previous note on event, is still continuing, and selecting, as element data to be used in generation of a new musical sound in response to the detected note on event, i) a piece of element data for which the note number in the detected note on event falls within the note number range, among element data of which sound generation type is the legato sound, if the note on state is still continuing, or ii) a piece of element data for which the note number in the detected note on event falls within the note number range, among element data of which sound generation type is the non-legato sound, if the note on state is not continuing; and
a generating step of generating, in accordance with the characteristic control data included in each piece of the element data selected in the selecting step, an element tone having sound characteristics indicated by the characteristic control data and pitch corresponding to the note number in the detected note on event.

10. A method for generating a musical sound by generating plural element tones based on plural pieces of element data and combining the generated element tones, comprising:
a step of preparing a memory that stores the plural pieces of element data corresponding to the plural element tones constituting a timbre of the musical sound, each piece of the element data including: limit data which indicates a velocity range in which corresponding element tone is generated; characteristic control data for controlling a sound characteristic of the corresponding element tone; and type data indicating whether the sound generation type of the element data is legato sound or non-legato sound;
a selecting step of judging, upon detecting a note on event which instructs to start generation of one musical sound and includes a velocity, whether or not note on state of an element tone, which is generated in accordance with element data of the legato sound or the non-legato sound in response to detection of previous note on event, is still continuing, and selecting, as element data to be used in generation of a new musical sound in response to the detected note on event, i) a piece of element data for which the velocity in the detected note on event falls within the velocity range, among element data of which sound generation type is the legato sound, if the note on state is still continuing, or ii) a piece of element data for which the velocity in the detected note on event falls within the velocity range, among element data of which sound generation type is the non-legato sound, if the note on state is not continuing; and
a generating step of generating, in accordance with the characteristic control data included in each piece of the element data selected in the selecting step, an element tone having sound characteristics indicated by the characteristic control data and volume corresponding to the velocity in the detected note on event.

11. A non-transitory computer readable storage medium storing program instructions executable by a computer and causing said computer to generate a musical sound by generating plural element tones based on plural pieces of element data and combining the generated element tones, and causing said computer to execute:
a step of preparing a memory that stores the plural pieces of element data corresponding to the plural element tones constituting a timbre of the musical sound, each piece of the element data including: limit data which indicates a note number range in which corresponding element tone is generated; characteristic control data for controlling a sound characteristic of the corresponding element tone; and type data indicating whether the sound generation type of the element data is legato sound or non-legato sound;
a selecting step of judging, upon detecting a note on event which instructs to start generation of one musical sound and includes a note number, whether or not note on state of an element tone, which is generated in accordance with element data of the legato sound or the non-legato sound in response to detection of previous note on event, is still continuing, and selecting, as element data to be used in generation of a new musical sound in response to the detected note on event, i) a piece of element data for which the note number in the detected note on event falls within the note number range, among element data of which sound generation type is the legato sound, if the note on state is still continuing, or ii) a piece of element data for which the note number in the detected note on event falls within the note number range, among element data of which sound generation type is the non-legato sound, if the note on state is not continuing; and
a generating step of generating, in accordance with the characteristic control data included in each piece of the element data selected in the selecting step, an element tone having sound characteristics indicated by the characteristic control data and pitch corresponding to the note number in the detected note on event.

12. A non-transitory computer readable storage medium storing program instructions executable by a computer and causing said computer to generate a musical sound by generating plural element tones based on plural pieces of element data and combining the generated element tones, and causing said computer to execute:
a step of preparing a memory that stores the plural pieces of element data corresponding to the plural element tones constituting a timbre of the musical sound, each piece of the element data including: limit data which indicates a velocity range in which corresponding element tone is generated; characteristic control data for controlling a sound characteristic of the corresponding element tone; and type data indicating whether the sound generation type of the element data is legato sound or non-legato sound;
a selecting step of judging, upon detecting a note on event which instructs to start generation of one musical sound and includes a velocity, whether or not note on state of an element tone, which is generated in accordance with element data of the legato sound or the non-legato sound in response to detection of previous note on event, is still continuing, and selecting, as element data to be used in generation of a new musical sound in response to the detected note on event, i) a piece of element data for which the velocity in the detected note on event falls within the velocity range, among element data of which sound generation type is the legato sound, if the note on state is still continuing, or ii) a piece of element data for which the velocity in the detected note on event falls within the velocity range, among element data of which sound generation type is the non-legato sound, if the note on state is not continuing; and
a generating step of generating, in accordance with the characteristic control data included in each piece of the element data selected in the selecting step, an element tone having sound characteristics indicated by the characteristic control data and volume corresponding to the velocity in the detected note on event.
